(19) United States
(12) Patent Application Publication
(10) Pub. No.: US 2024/0040548 A1
(43) Pub. Date: Feb. 1, 2024

(54) WIRELESS COMMUNICATION APPARATUS AND WIRELESS COMMUNICATION SYSTEM

(71) Applicant: Sharp Kabushiki Kaisha, Sakai City, Osaka (JP)

(72) Inventors: Atsushi SHIRAKAWA, Sakai City (JP); Hiromichi TOMEBA, Sakai City (JP); Hideo NAMBA, Sakai City (JP); Yasuhiro HAMAGUCHI, Sakai City (JP)

(21) Appl. No.: 18/019,513

(22) PCT Filed: Aug. 31, 2021
(86) PCT No.: PCT/JP2021/031829

§ 371 Date: Feb. 3, 2023

(30) Foreign Application Priority Data
Sep. 2, 2020 (JP) 2020-147206

(51) Int. Cl. H04W 72/04; H04W 72/20

(52) U.S. Cl. CPC H04W 72/04; H04W 72/20

(57) ABSTRACT

In a wireless communication system including a first sub-wireless communication system for managing a first radio resource and a second sub-wireless communication system for managing a second radio resource, a terminal apparatus connected to the first sub-wireless communication system is capable of performing communication using the second radio resource in addition to the first radio resource.

### TECHNICAL FIELD

The present invention relates to a wireless communication apparatus and a wireless communication system.

This application claims priority based on JP 2020-147206 filed on Sep. 2, 2020, the contents of which are incorporated herein by reference.

### BACKGROUND ART

IEEE 802.11ax for realizing a higher speed in IEEE 802.11 which is a wireless local area network (LAN) standard, has been standardized by the Institute of Electrical and Electronics Engineers Inc. (IEEE), and wireless LAN devices conforming to the draft specification have appeared in the market. The standardization of IEEE 802.11be as a standard subsequent to IEEE 802.11ax has been started recently. As the wireless LAN devices are widely used, further improvement in throughput per user in environments where wireless LAN devices are densely disposed has been studied in the standardization of IEEE 802.11be.

In a wireless LAN, frames can be transmitted using unlicensed bands that enable wireless communication without requiring permission (license) from a country or a region. In applications for individuals, such as for home uses, access to the Internet from inside residences has been realized wirelessly by, for example, implementing the wireless LAN access point function in a line termination apparatus for connecting to a Wide Area Network (WAN) line such as the Internet, or connecting a wireless LAN access point apparatus to the line termination apparatus. That is, wireless LAN station apparatuses such as a smartphone and a personal computer (PC) can be connected to the wireless LAN access point apparatus to access the Internet. When the wireless LAN for home uses was initially introduced, the number of wireless LAN access point apparatuses installed in a residence was mostly one, and multiple wireless LAN access point apparatuses have been introduced recently, providing wide coverage to use wireless LAN area inside a residence. In particular, for personal applications, a wireless LAN mesh network in which wireless LAN access point apparatuses (backhaul) wirelessly communicate with each other is preferred in order to simplify the network construction. On the other hand, for corporate applications (for enterprises), wired connections, such as the Ethernet (registered tradename), between wireless LAN access point apparatuses are preferred in order to increase reliability in frame transmission. In addition, since the communication performance and the complexity of apparatus installation are in a trade-off relationship, whether to apply a wireless connection or wired connection between wireless LAN access point apparatuses may be determined according to a use case in consideration of balance in the relationship.

Furthermore, in the standardization of IEEE 802.11be, Multi Access Point (Multi-AP) has been discussed that allows multiple wireless LAN access point apparatuses to coordinate to transmit and/or receive frames with respect to one wireless LAN station apparatus (see NPL 1). In the related art, basically, a wireless LAN access point apparatus transmits frames in consideration of only the wireless LAN station apparatus connected to the wireless LAN access point apparatus itself. However, the wireless LAN access point apparatus in the Multi-AP wireless communication system may be able to perform coordinated operation with another wireless LAN access point apparatus to transmit frames in consideration of the wireless LAN station apparatus connected to the other wireless LAN access point apparatus. In coordinated OFDMA, which is an example coordinated operation, frequency channels available to the Multi-AP wireless communication system are distributed and allocated to wireless LAN access point apparatuses so as to be orthogonal in the frequency axis direction. The resource allocated to each wireless LAN access point apparatus, without depending on other wireless LAN access point apparatuses, can independently be used for downlink communication (in the direction from a wireless LAN access point apparatus to a wireless LAN station apparatus) with the station apparatus connected to the wireless LAN access point apparatus itself and uplink communication (in the direction from a wireless LAN station apparatus to a wireless LAN access point apparatus). Among wireless LAN communication systems constituting one coordinated OFDMA transmission and/or reception, congestion caused by contention-based access does not occur in using radio resources, and the radio resources can be efficiently shared and used by further performing division into transmission time periods and reception time periods.

### CITATION LIST

### Non Patent Literature

NPL 1: IEEE 802.11-20/0064-01-0be, January 2020.

### SUMMARY OF INVENTION

### Technical Problem

In the coordinated OFDMA, sizes of frequency channels and frequency resources allocated to wireless LAN communication systems are basically common to downlink communication and uplink communication. For example, in a case that a frequency band of 40 MHz is allocated for downlink communication of a certain wireless LAN communication system, a frequency bandwidth of 40 MHz is also allocated for uplink communication. In a case that, in a certain wireless LAN communication system, a wide frequency bandwidth is needed for a large amount of downlink communication data but a wide frequency bandwidth is unnecessary for a relatively small amount of uplink communication data, frequency resources are unnecessarily consumed in the uplink communication period.

### Solution to Problem

A communication apparatus and a communication method according to an aspect of the present invention for solving the aforementioned problem are as follows.

(1) That is, a terminal apparatus according to an aspect of the present invention is a terminal apparatus for connecting, in a wireless communication system including a first sub-wireless communication system for managing a first radio resource and a second sub-wireless communication system for managing second radio resource, to the first sub-wireless communication system, wherein the terminal apparatus is capable of performing communication using the second radio resource in addition to the first radio resource.

(2) With respect to the terminal apparatus according to an aspect of the present invention described in (1) above, the second radio resource used for the communication is associated with an identifier of the terminal apparatus in the first sub-wireless communication system, and is notified in control information of the first sub-wireless communication system.

(3) In addition, with respect to the terminal apparatus according to an aspect of the present invention described in (1) above, the second radio resource used for the communication is associated with an identifier of the terminal apparatus in the wireless communication system, and is notified in control information of the second sub-wireless communication system.

(4) A terminal apparatus according to an aspect of the present invention is a terminal apparatus for connecting, in a wireless communication system including a first sub-wireless communication system and a second sub-wireless communication system, to the first sub-wireless communication system, in which downlink communication is configured to be performed using a first radio resource managed by the first sub-wireless communication system, and uplink communication is configured to be performed using a second radio resource managed by the second sub-wireless communication system, in addition to the first radio resource.

(5) In addition, with respect to the terminal apparatus according to an aspect of the present invention described in (4) above, the second radio resource used for the uplink communication is associated with an identifier of the terminal apparatus in the first sub-wireless communication system, and is notified in control information of the first sub-wireless communication system.

(6) In addition, with respect to the terminal apparatus according to an aspect of the present invention described in (4) above, the second radio resource used for the uplink communication is associated with an identifier of the terminal apparatus in the wireless communication system, and is notified in control information of the second sub-wireless communication system.

(7) A terminal apparatus according to an aspect of the present invention is a terminal apparatus for connecting, in a wireless communication system including a first sub-wireless communication system and a second sub-wireless communication system, to the first sub-wireless communication system, in which uplink communication is configured to be performed using a first radio resource managed by the first sub-wireless communication system, and downlink communication is configured to be performed using a second radio resource managed by the second sub-wireless communication system, in addition to the first radio resource.

(8) In addition, with respect to the terminal apparatus according to an aspect of the present invention described in (7) above, the second radio resource used for the downlink communication is associated with an identifier of the terminal apparatus in the first sub-wireless communication system, and is notified in control information of the first sub-wireless communication system.

(9) In addition, with respect to the terminal apparatus according to an aspect of the present invention described in (7) above, the second radio resource used for the downlink communication is associated with an identifier of the terminal apparatus in the wireless communication system, and is notified in control information of the second sub-wireless communication system.

(10) A wireless communication system according to an aspect of the present invention is a wireless communication system including a first sub-wireless communication system and a second sub-wireless communication system, in which communication of a terminal apparatus connected to the first sub-wireless communication system is configured to be performed using a second radio resource managed by the second sub-wireless communication system in addition to a first radio resource managed by the first sub-wireless communication system.

(11) With respect to the wireless communication system according to an aspect of the present invention described in (10) above, the second radio resource used for the communication of the terminal apparatus is associated with an identifier of the terminal apparatus in the first sub-wireless communication system, and is notified in control information of the first sub-wireless communication system.

(12) With respect to the wireless communication system according to an aspect of the present invention described in (10) above, the second radio resource used for the communication of the terminal apparatus is associated with an identifier of the terminal apparatus in the wireless communication system, and is notified in control information of the second sub-wireless communication system.

(13) With respect to the wireless communication system according to an aspect of the present invention described in (10) above, the second radio resource used for the communication of the terminal apparatus is configured to be used on a contention basis.

### Advantageous Effects of Invention

According to one aspect of the present invention, in a Multi-AP wireless communication system configured by a plurality of sub-wireless communication systems, radio resources, managed by an access point apparatus included in a certain sub-wireless communication system, are allowed to be shared with another sub-wireless communication system, and thus radio resources can be efficiently used in the Multi-AP wireless communication system.

### BRIEF DESCRIPTION OF DRAWINGS

FIG. 1 is a diagram illustrating an example of a frame configuration according to an aspect of the present invention.

FIG. 2 is a diagram illustrating an example of a frame configuration according to an aspect of the present invention.

FIG. 3 is a diagram illustrating an example of communication according to an aspect of the present invention.

FIG. 4 is a schematic diagram illustrating an example of splitting radio resources according to an aspect of the present invention.

FIG. 5 is a diagram illustrating a configuration example of a communication system according to an aspect of the present invention.

FIG. 6 is a block diagram illustrating a configuration example of a wireless communication apparatus according to an aspect of the present invention.

FIG. 7 is a block diagram illustrating a configuration example of a wireless communication apparatus according to an aspect of the present invention.

FIG. 8 is a schematic diagram illustrating an example of a coding scheme according to an aspect of the present invention.

FIG. 9 is a diagram illustrating an example of a frame configuration according to an aspect of the present invention.

FIG. 10 is an example of information of frame addresses according to an aspect of the present invention.

FIG. 11 is an example of a frame sequence of a communication system according to an aspect of the present invention.

FIG. 12 is an example of a frame sequence of a communication system according to an aspect of the present invention.

FIG. 13 is a schematic diagram illustrating an example of splitting radio resources according to an aspect of the present invention.

FIG. 14 is a schematic diagram illustrating an example of splitting radio resources according to an aspect of the present invention.

FIG. 15 is a schematic diagram illustrating an example of splitting radio resources according to an aspect of the present invention.

FIG. 16 is a schematic diagram illustrating a relationship between radio resources and unique control information according to an aspect of the present invention.

FIG. 17 is a schematic diagram illustrating a relationship between radio resources and unique control information according to an aspect of the present invention.

FIG. 18 is a schematic diagram illustrating a relationship between radio resources and unique control information according to an aspect of the present invention.

FIG. 19 is a schematic diagram illustrating a relationship between radio resources and unique control information according to an aspect of the present invention.

### DESCRIPTION OF EMBODIMENTS

A communication system according to the present embodiment includes a wireless transmission apparatus (access point apparatus, base station apparatus: access point, base station apparatus), and a plurality of wireless reception apparatuses (station apparatus, terminal apparatus: station, terminal apparatus). In addition, a network composed of a base station apparatus and a terminal apparatus is called a basic service set (BSS or control range). In addition, the station apparatus according to the present embodiment can have functions of an access point apparatus. Similarly, the access point apparatus according to the present embodiment can have functions of the station apparatus. Thus, in a case that a communication apparatus is simply mentioned below, the communication apparatus may indicate both a station apparatus and an access point apparatus.

A base station apparatus and a terminal apparatus in a BSS are assumed to perform communication based on carrier-sense multiple access with collision avoidance (CSMA/CA). Although an infrastructure mode in which the base station apparatus performs communication with a plurality of terminal apparatuses is targeted in the present embodiment, a method of the present embodiment can also be performed in an ad hoc mode in which terminal apparatuses perform communication directly with each other. In the ad hoc mode, the terminal apparatuses form a BSS instead of the base station apparatus. The BSS in the ad hoc mode will also be referred to as an Independent Basic Service Set (IBSS). In the following description, a terminal apparatus that forms an IBSS in the ad hoc mode can also be regarded as a base station apparatus. The method of the present embodiment can also be performed in Wi-Fi Direct (registered trademark) in which terminal apparatuses perform communicate directly with each other. In Wi-Fi Direct, the terminal apparatuses form a Group instead of the base station apparatus. Hereinafter, a terminal apparatus as a Group owner forming a Group in Wi-Fi Direct can also be regarded as a base station apparatus.

In an IEEE 802.11 system, each apparatus can transmit transmission frames of a plurality of frame types in a common frame format. Each transmission frame is defined by a physical (PHY) layer, a Medium Access Control (MAC) layer, and a Logical Link Control (LLC) layer.

A transmission frame of the PHY layer will be referred to as a physical protocol data unit (PPDU: PHY protocol data unit or physical layer frame). The PPDU includes a physical layer header (PHY header) including header information and the like for performing signal processing in the physical layer, a physical service data unit (PSDU: PHY service data unit or MAC layer frame) that is a data unit processed in the physical layer, and the like. The PSDU can include an Aggregated MPDU (A-MPDU) in which a plurality of MAC protocol data units (MPDUs) as a retransmission unit in a radio section are aggregated.

The PHY header includes reference signals such as a short training field (STF) used for detection, synchronization, and the like of signals, a long training field (LTF) used for obtaining channel information for data demodulation, and the like and a control signal such as a signal (SIG) including control information for data demodulation. Also, the STF is classified into a Legacy-STF (L-STF), a High throughput-STF (HT-STF), a Very high throughput-STF (VHT-STF), a High efficiency-STF (HE-STF), an Extremely High Throughput-STF (EHT-STF), and the like in accordance with compliant standards, and the LTF and the SIG are also similarly classified into an L-LTF, an HT-LTF, a VHT-LTF, an HE-LTF, an L-SIG, an HT-SIG, a VHT-SIG, an HE-SIG, and an EHT-SIG. The VHT-SIG is further classified into VHT-SIG-A1, VHT-SIG-A2, and VHT-SIG-B. Similarly, the HE-SIG is classified into HE-SIG-A1 to 4 and HE-SIG-B. In addition, on the assumption of updating of technologies in the same standard, a Universal SIGNAL (U-SIG) field including additional control information can be included.

Furthermore, the PHY header can include information for identifying a BSS of a transmission source of the transmission frame (hereinafter, also referred to as BSS identification information). The information for identifying the BSS can be, for example, a Service Set Identifier (SSID) of the BSS or a MAC address of a base station apparatus of the BSS. In addition, the information for identifying the BSS can be a value unique to the BSS (e.g., a BSS Color, etc.) other than the SSID and the MAC address.

The PPDU is modulated in accordance with the corresponding standard. In the IEEE 802.11n standard, for example, the PPDU is modulated into an orthogonal frequency division multiplexing (OFDM) signal.

An MPDU includes a MAC layer header (MAC header) including header information and the like for performing signal processing in the MAC layer, a MAC service data unit (MSDU) that is a data unit processed in the MAC layer or a frame body, and a Frame check sequence (FCS) for checking whether there is an error in the frame. In addition, a plurality of MSDUs can be aggregated as an Aggregated MSDU (A-MSDU).

Frame types of transmission frames of the MAC layer are classified broadly into three frame types, namely a management frame for managing a state of connection between apparatuses, and the like, a control frame for managing a state of communication between apparatuses, and a data frame including actual transmission data, and each frame type is further classified into a plurality of subframe types. The control frame includes an Acknowledge (Ack) frame, a Request to send (RTS) frame, a Clear to send (CTS) frame, and the like. The management frame includes a Beacon frame, a Probe request frame, a Probe response frame, an Authentication frame, a connection (Association) request frame, a connection (Association) response frame, and the like. The data frame includes a Data frame, a polling (CF-poll) frame, and the like. Each apparatus can recognize the frame type and the subframe type of a received frame by reading the content of the frame control field included in the MAC header.

Further, an Ack may include a Block Ack. A Block Ack can give a reception completion notification to a plurality of MPDUs.

The beacon frame includes a Field in which an interval at which a beacon is transmitted (Beacon interval) and an SSID are stated. A base station apparatus can periodically report the BSS of the beacon frame, and each terminal apparatus can recognize the base station apparatus in the surroundings of the terminal apparatus by receiving the beacon frame. The action of the terminal apparatus to recognize the base station apparatus based on the beacon frame reported by the base station apparatus will be referred to as passive scanning. On the other hand, the action of the terminal apparatus to search for the base station apparatus by reporting a probe request frame in a BSS will be referred to as active scanning. The base station apparatus can transmit a probe response frame as a response to the probe request frame, and detail indicated in the probe response frame is equivalent to that in the beacon frame.

The terminal apparatus recognizes the base station apparatus and then performs a process to connect to the base station apparatus. This connection process is divided into an authentication procedure and a connection (Association) procedure. The terminal apparatus transmits an authentication frame (authentication request) to the base station apparatus that the terminal apparatus desires to connect to. After receiving the authentication frame, the base station apparatus transmits, to the terminal apparatus, an authentication frame (authentication response) including a status code indicating whether the terminal apparatus can be authenticated, or the like. The terminal apparatus can determine whether the terminal apparatus has been authenticated by the base station apparatus by reading the status code indicated in the authentication frame. Further, the base station apparatus and the terminal apparatus can exchange such authentication frames a plurality of times.

After the authentication procedure, the terminal apparatus transmits a connection (association) request frame to the base station apparatus in order to perform the connection (association) procedure. After receiving the connection (association) request frame, the base station apparatus determines whether to allow connection of the terminal apparatus and transmits a connection (association) response frame to give a notification regarding the determination. In the connection (association) response frame, an association identifier (AID) for identifying the terminal apparatus is indicated in addition to the status code indicating whether to perform the connection (association) process. The base station apparatus can manage a plurality of terminal apparatuses by configuring different AIDs for the terminal apparatuses which the base station apparatus has allowed for connection.

After the connection (association) process is performed, the base station apparatus and the terminal apparatus perform actual data transmission. In the IEEE 802.11 system, a Distributed Coordination Function (DCF), a Point Coordination Function (PCF), and a function in which the DCF and the PCF are enhanced (an Enhanced Distributed Channel Access (EDCA), a Hybrid Coordination Function (HCF), and the like) are defined. A case that the base station apparatus transmits signals to the terminal apparatus using the DCF will be described below as an example.

In the DCF, the base station apparatus and the terminal apparatus perform carrier sensing (CS) for checking a use condition of a radio channel in the surroundings of the apparatuses themselves prior to communication. For example, in a case that the base station apparatus being a transmitting station receives a signal at a higher level than a predefined Clear Channel Assessment level (CCA level) on the radio channel, the base station apparatus postpones transmission of a transmission frame through the radio channel Hereinafter, a state in which a signal at a level that is equal to or higher than the CCA level is detected on the radio channel will be referred to as a busy state, and a state in which a signal at a level that is equal to or higher than the CCA level is not detected will be referred to as an idle state. In this manner, CS performed based on the power (reception power level) of a signal actually received by each apparatus will be referred to as physical carrier sensing (physical CS). Further, a CCA level will also be referred to as a carrier sensing level (CS level) or a CCA threshold (CCAT). Further, in a case that a signal at a level that is equal to or higher than the CCA level is detected, the base station apparatus and the terminal apparatus start performing an operation of demodulating at least a signal of the PHY layer.

The base station apparatus performs carrier sensing for an Inter Frame Space (IFS) in accordance with the type of transmission frame to be transmitted and determines whether the radio channel is in the busy state or the idle state. The period during which the base station apparatus performs carrier sensing differs depending on the frame type and the subframe type of transmission frame to be transmitted by the base station apparatus from that time. In the IEEE 802.11 system, a plurality of IFSs with different periods are defined, and there are a short inter frame space (Short IFS or SIFS) used for a transmission frame with the highest priority, a polling inter frame interval (PCF IFS or PIFS) used for a transmission frame with a relatively high priority, a distributed control inter frame interval (DCF IFS or DIFS) used for a transmission frame with the lowest priority, and the like. In a case that the base station apparatus transmits a data frame with the DCF, the base station apparatus uses the DIFS.

The base station apparatus waits for the DIFS and then further waits for a random backoff time to prevent frame collision. In the IEEE 802.11 system, a random backoff time called a Contention Window (CW) is used. CSMA/CA is based on the assumption that a transmission frame transmitted by a certain transmitting station is received by a receiving station in a state with no interference from other transmitting stations. For this reason, if transmitting stations transmit transmission frames at the same timing, the frames collide with each other, and thus the receiving station cannot receive them properly. Thus, if each of transmitting stations waits for a randomly configured time before starting transmission, collision of the frames can be avoided. When the base station apparatus determines, through carrier sensing, that a radio channel is in the idle state, the base station apparatus starts counting down a CW then acquires a transmission right for the first time after the CW becomes zero and can transmit a transmission frame to the terminal apparatus. Further, in a case that the base station apparatus determines, through the carrier sensing, that the radio channel is in the busy state while counting down the CW, the base station apparatus stops the countdown of the CW. In addition, in a case that the radio channel is in the idle state, the base station apparatus restarts the countdown of the remaining CW succeeding to the previous IFS.

The terminal apparatus that is a receiving station receives the transmission frame, reads the PHY header of the transmission frame, and demodulates the received transmission frame. Then, the terminal apparatus can recognize whether the transmission frame is addressed to the terminal apparatus itself by reading the MAC header of the demodulated signal. Further, the terminal apparatus can also determine the destination of the transmission frame based on the information indicated in the PHY header (e.g., a Group identifier (Group ID or GID) listed in the VHT-SIG-A).

In a case that the terminal apparatus determines that the received transmission frame is addressed to the terminal apparatus itself and can demodulate the transmission frame without any error, the terminal apparatus has to transmit an ACK frame indicating that the frame has been properly received to the base station apparatus that is the transmitting station. The ACK frame is one of transmission frames with the highest priority transmitted only after a wait for an SIFS period (with no random backoff time). The base station apparatus ends the series of communication after receiving the ACK frame transmitted from the terminal apparatus. Further, in a case that the terminal apparatus is not able to receive the frame properly, the terminal apparatus does not transmit ACK. Thus, the base station apparatus ends the communication after the frame transmission assuming that the communication has failed in a case that the ACK frame was not received from the receiving station for a certain period (the length of SIFS+ACK frame). In this manner, an end of single communication (also called a burst) of the IEEE 802.11 system is necessarily determined based on whether an ACK frame has been received, except for special cases, for example, in a case that a broadcast signal such as a beacon frame is transmitted, or in a case that fragmentation for splitting transmission data is used.

In a case that the terminal apparatus determines that the received transmission frame is not addressed to the terminal apparatus itself, the terminal apparatus configures a Network Allocation Vector (NAV) based on the length of the transmission frame indicated in the PHY header or the like. The terminal apparatus does not try communication during a period configured in the NAV. That is, the terminal apparatus performs, for the period configured in the NAV, the same operation as the operation in a case that the radio channel is determined to be in a busy state through physical CS, the communication control based on the NAV is also called virtual carrier sensing (virtual CS). The NAV is also configured by a Request to send (RTS) frame introduced to solve a hidden terminal problem and a Clear to send (CTS) frame, in addition to a case where the NAV is configured based on the information indicated in the PHY header.

Compared to the DCF in which each apparatus performs carrier sensing and autonomously acquires a transmission right, in the PCF, a control station called a Point Coordinator (PC) controls a transmission right of each apparatus inside the BSS. In general, the base station apparatus serves as a PC and acquires a transmission right with respect to terminal apparatuses inside the BSS.

A communication period using the PCF includes a Contention Free Period (CFP) and a Contention Period (CP). During a CP, communication is performed based on the aforementioned DCF, and the period in which a PC controls a transmission right is a CFP. The base station apparatus that is a PC reports a beacon frame with indication of duration of a CFP (CFP Max duration) and the like into the BSS prior to communication of the PCF. Further, a PIFS is used to transmit the beacon frame reported at the time of starting transmission of the PCF, and the beacon frame is transmitted without waiting for a CW. The terminal apparatus that has received the beacon frame configures the CFP Max duration indicated in the beacon frame to the NAV. Hereinafter, the terminal apparatus can acquire the transmission right only in a case that a signal (e.g., a data frame including CF-poll) for signaling acquisition of a transmission right transmitted by the PC is received, until the NAV elapses or a signal (e.g., a data frame including CF-end) for reporting the end of the CFP into the BSS is received. Further, because no packet collision occurs inside the same BSS within the CFP Max duration, each terminal apparatus does not take a random backoff time used in the DCF.

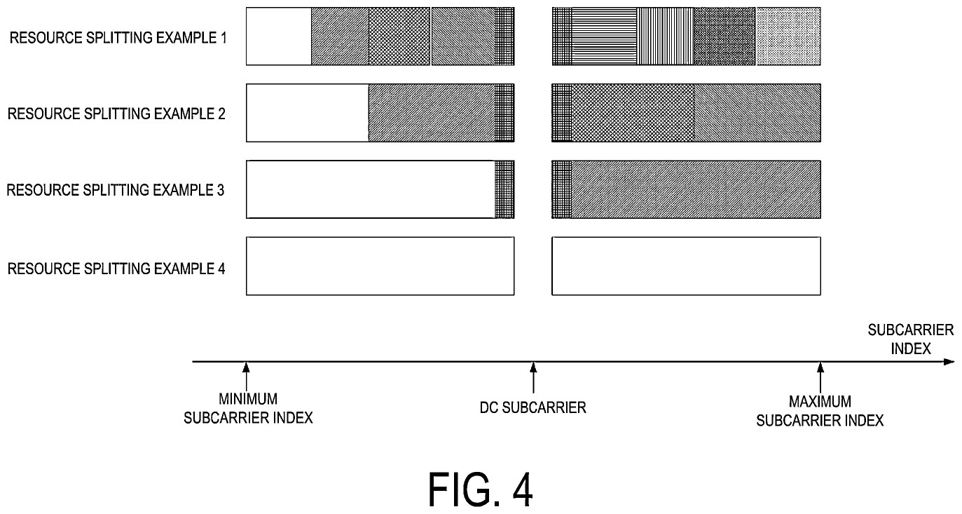

A radio medium can be split into a plurality of resource units (RUs). FIG. 4 is a schematic diagram illustrating an example of a state of split wireless media. In the resource splitting example 1, for example, a wireless communication apparatus can split a frequency resource (subcarrier) that is a radio medium into nine RUs. Similarly, in the resource splitting example 2, the wireless communication apparatus can split a subcarrier that is a radio medium into five RUs. It is a matter of course that the resource splitting examples illustrated in FIG. 4 are merely examples, and for example, each of the plurality of RUs can include a different number of subcarriers. Moreover, the radio medium split into RUs can include not only frequency resources but also spatial resources. The wireless communication apparatus (e.g., AP) can transmit frames to a plurality of terminal apparatuses (e.g., a plurality of STAs) at the same time by arranging the frames addressed to different terminal apparatuses in each of the RUs. The AP can describe information (resource allocation information) indicating a state of the split radio medium as common control information in the PHY header of the frame transmitted by the AP itself. Moreover, the AP can describe information (resource unit assignment information) indicating the RU where frames addressed to each STA are arranged as unique control information in the PHY header of the frame transmitted by the AP itself.

In addition, a plurality of terminal apparatuses (e.g., a plurality of STAs) can transmit frames at the same time by transmitting each of the frames arranged in the allocated RUs. The plurality of STAs can perform frame transmission after waiting for a predetermined period after receiving a frame (trigger frame or TF) including trigger information transmitted from the AP. Each STA can ascertain the RUs allocated to the apparatus itself based on the information indicated in the TF. In addition, each STA can acquire the RUs through random access with reference to the TF.

The AP can allocate a plurality of RUs to one STA at the same time. The plurality of RUs can include continuous subcarriers or discontinuous subcarriers. The AP can transmit one frame using a plurality of RUs allocated to one STA or can transmit a plurality of frames after allocating the frames to different RUs. At least one of the plurality of frames can be a frame including common control information for a plurality of terminal apparatuses that transmit Resource allocation information.

One STA can use a plurality of RUs allocated by the AP. The STA can transmit one frame using the plurality of allocated RUs. In addition, the STA can use the plurality of allocated RUs to transmit a plurality of frames after allocating the frames to different RUs. The plurality of frames can include frames of different frame types.

The AP can also allocate a plurality of AIDs to one STA. The AP can allocate each of the RUs to the plurality of AIDs allocated to the one STA. The AP can transmit different frames using the RUs allocated to the plurality of AIDs allocated to the one STA. The different frames can be frames of different frame types.

The one STA can use a plurality of AIDs allocated by the AP. The one STA can allocate each of the RUs to the plurality of allocated AIDs. The one STA recognizes all of the RUs allocated to the plurality of AIDs allocated to the STA itself as RUs allocated to the STA itself and can transmit one frame using the plurality of allocated RUs. In addition, the one STA can transmit a plurality of frames using the plurality of allocated RUs. At this time, the plurality of frames can be transmitted with information indicating the AIDs associated with each of the allocated RUs indicated therein. The AP can transmit different frames using the RUs allocated to the plurality of AIDs allocated to the one STA. The different frames can be frames of different frame types.

Hereinafter, the base station apparatus and the terminal apparatuses will be collectively referred to as wireless communication apparatuses or communication apparatuses. In addition, information exchanged when a certain wireless communication apparatus communicates with another wireless communication apparatus will also be referred to as data. In other words, examples of the wireless communication apparatus include base station apparatuses and terminal apparatuses.

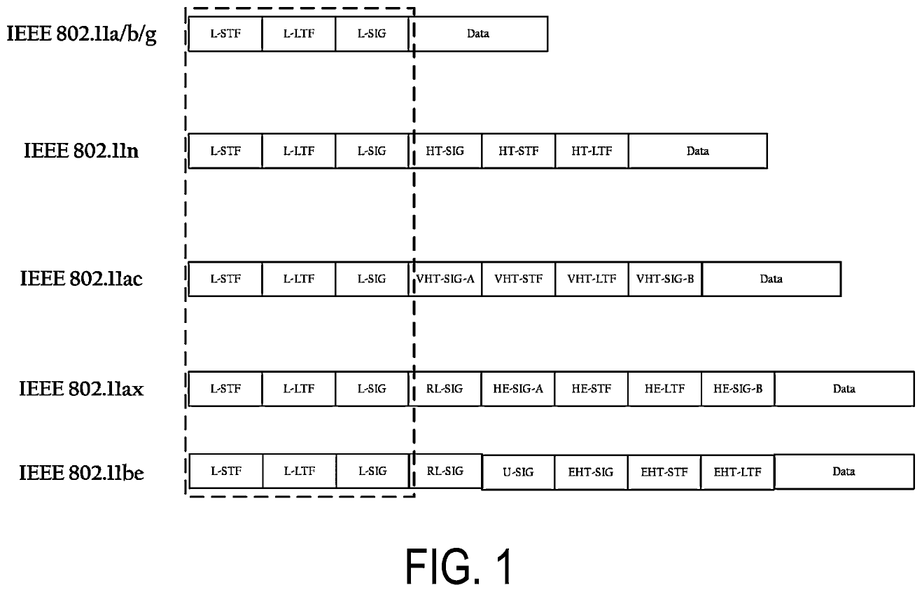

The wireless communication apparatus includes any one of or both a function of transmitting a PPDU and a function of receiving a PPDU. FIG. 1 is a diagram illustrating examples of a configuration of the PPDU transmitted by the wireless communication apparatus. The PPDU that is compliant with the IEEE 802.11a/b/g standards includes L-STF, L-LTF, L-SIG, and a Data frame (a MAC Frame, a MAC frame, a payload, a data part, data, information bits, and the like). The PPDU that is compliant with the IEEE 802.11n standard includes L-STF, L-LTF, L-SIG, HT-SIG, HT-STF, HT-LTF, and a Data frame. The PPDU that is compliant with the IEEE 802.11ac standard includes some or all of L-STF, L-LTF, L-SIG, VHT-SIG-A, VHT-STF, VHT-LTF, VHT-SIG-B, and a MAC frame. The PPDU studied in the IEEE 802.11ax standard includes some or all of L-STF, L-LTF, L-SIG, RL-SIG in which L-SIG is temporally repeated, HE-SIG-A, HE-STF, HE-LTF, HE-SIG-B, and a Data frame. The PPDU studied in the IEEE 802.11be standard includes some or all of L-STF, L-LTF, L-SIG, RL-SIG, U-SIG, EHT-SIG, EHT-STF, HET-LTF, and a Data frame.

L-STF, L-LTF, and L-SIG surrounded by the dotted line in FIG. 1 are configurations commonly used in the IEEE 802.11 standard (hereinafter, L-STF, L-LTF, and L-SIG will also be collectively referred to as an L-header). For example, a wireless communication apparatus that is compliant with the IEEE 802.11a/b/g standards can appropriately receive the L-header inside a PPDU that is compliant with the IEEE 802.11n/ac standards. The wireless communication apparatus that is compliant with the IEEE 802 11a/big standards can receive the PPDU that is compliant with the IEEE 802 11n/ac standards while regarding it as a PPDU that is compliant with the IEEE 802.11a/b/g standards.

However, because the wireless communication apparatus that is compliant with the IEEE 802.11a/b/g standards cannot demodulate the PPDU that is compliant with the IEEE 802.11n/ac standards following the L-header, it is not possible to demodulate information about a Transmitter Address (TA), a Receiver Address (RA), and a Duration/ID field used for configuring an NAV.

As a method for the wireless communication apparatus that is compliant with the IEEE 802.11a/b/g standards to appropriately configure an NAV (or perform a receiving operation for a predetermined period), the IEEE 802.11 defines a method of inserting Duration information to L-SIG. Information about a transmission speed in L-SIG (a RATE field, an L-RATE field, an L-RATE, an L_DATARATE, and an L_DATARATE field), and information about a transmission period (a LENGTH field, an L-LENGTH field, and an L-LENGTH) are used by the wireless communication apparatus that is compliant with the IEEE 802.11a/b/g standards to appropriately configure an NAV.

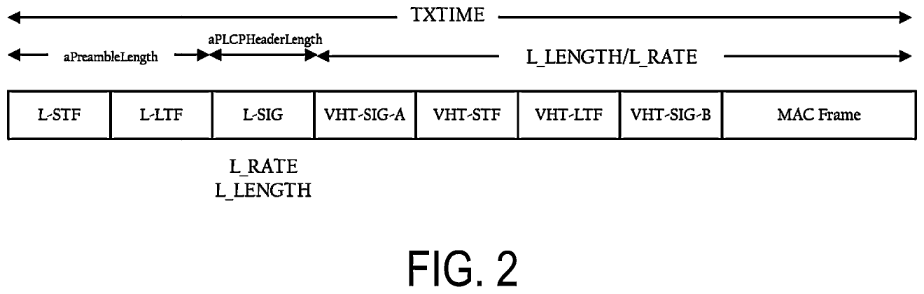

FIG. 2 is a diagram illustrating an example of a method of Duration information inserted into L-SIG. Although a PPDU configuration that is compliant with the IEEE 802.11ac standard is illustrated as an example in FIG. 2, a PPDU configuration is not limited thereto. A PPDU configuration that is compliant with the IEEE 802.11n standard and a PPDU configuration that is compliant with the IEEE 802.11ax standard may be employed. TXTIME includes information about the length of the PPDU, aPreambleLength includes information about the length of a preamble (L-STF+L-LTF), and aPLCPHeaderLength includes information about the length of a PLCP header (L-SIG). L_LENGTH is calculated based on Signal Extension that is a virtual period configured for compatibility with the IEEE 802.11 standard, Nₒₚₛ related to L-RATE, aSymbolLength that is information about the period of one symbol (a symbol, an OFDM symbol, or the like), aPLCPServiceLength indicating the number of bits included in a PLCP Service field, and aPLCPConvolutionalTailLength indicating the number of tail bits of a convolution code. The wireless communication apparatus can calculate L_LENGTH and insert L_LENGTH into L-SIG. In addition, the wireless communication apparatus can calculate L-SIG Duration. L-SIG Duration indicates information about a period that is the sum of a PPDU including L_LENGTH and the periods of Ack and SIFS expected to be transmitted by the destination wireless communication apparatus in response to the PPDU.

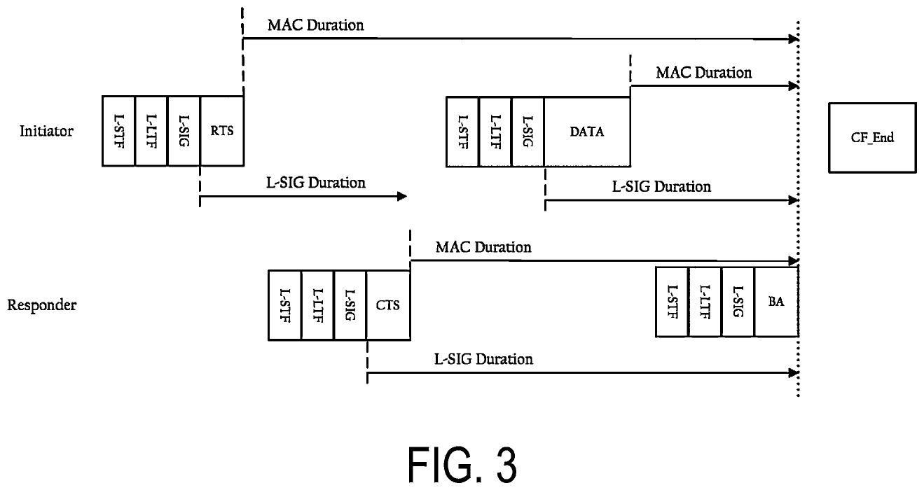

FIG. 3 is a diagram illustrating an example of L-SIG Duration in L-SIG TXOP Protection. DATA (a frame, a payload, data, and the like) include some of or both the MAC frame and the PLCP header. In addition, a BA includes a Block Ack or an Ack. A PPDU includes L-STF, L-LTF, and L-SIG and can further includes any one or more of DATA, BA, RTS, and CTS. Although L-SIG TXOP Protection using RTS/CTS is illustrated in the example illustrated in FIG. 3, CTS-to-Self may be used. Here, MAC Duration is a period indicated by a value of Duration/ID field. In addition, Initiator can transmit a CF_End frame for providing a notification regarding an end of the L-SIG TXOP Protection period.

Next, a method of identifying a BSS from a frame received by a wireless communication apparatus will be described. In order for a wireless communication apparatus to identify a BSS from a received frame, the wireless communication apparatus that transmits a PPDU preferably inserts information (BSS color, BSS identification information, and a value unique to the BSS) for identifying the BSS into the PPDU. The information indicating the BSS color can be indicated in HE-SIG-A.

The wireless communication apparatus can transmit L-SIG a plurality of times (L-SIG Repetition). For example, accuracy in demodulation of L-SIG is improved by the wireless communication apparatus on the reception side receiving L-SIG transmitted a plurality of times by using Maximum Ratio Combining (MRC). Moreover, in a case that reception of L-SIG has been properly completed using MRC, the wireless communication apparatus can interpret the PPDU including the L-SIG as a PPDU that is compliant with the IEEE 802.11ax standard.

Even during the operation of receiving the PPDU, the wireless communication apparatus can perform an operation of receiving a part of a PPDU other than the PPDU (e.g., the preamble, L-STF, L-LTF, the PLCP header defined by IEEE 802.11, etc.) (also referred to as a double-reception operation). In a case that a part of a PPDU other than the PPDU is detected during the operation of receiving the PPDU, the wireless communication apparatus can update a part or the entirety of information about the destination address, the transmission source address, the PPDU, or the DATA period.

An Ack and a BA can also be referred to as a response (response frame). In addition, a probe response, an authentication response, and a connection response can also be referred to as a response.

### 1. First Embodiment

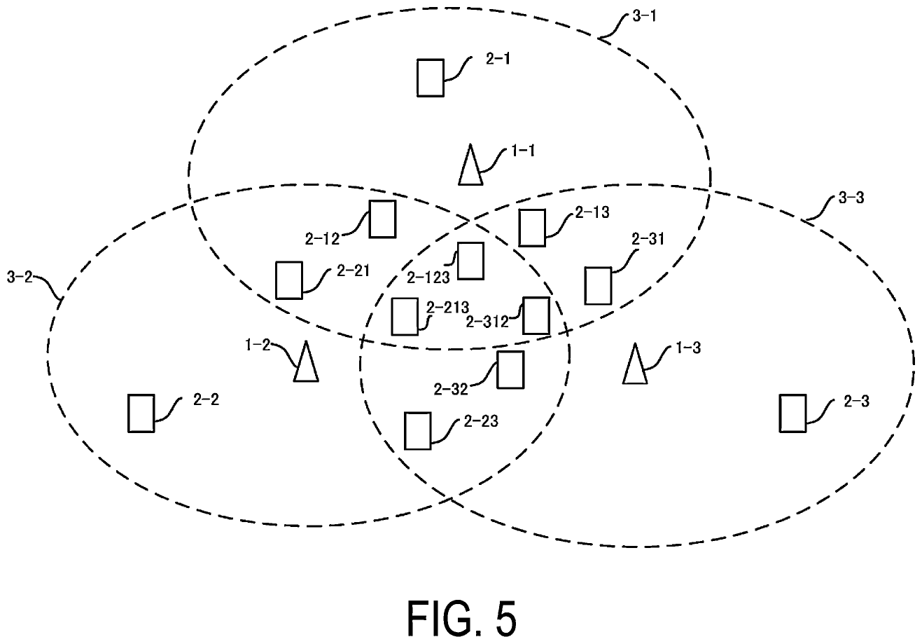

A Multi-AP wireless communication system includes a wireless communication system provided by two or more access point apparatuses. FIG. 5 is a diagram illustrating an example of a Multi-AP wireless communication system according to the present embodiment, and is an example including three systems including a wireless communication system 3-1, a wireless communication system 3-2, and a wireless communication system 3-3. The wireless communication system 3-1, the wireless communication system 3-2, and the wireless communication system 3-3 are sub-wireless communication system constituting a Multi-AP wireless communication system, and are also referred to as a sub-wireless communication system 3-1, a sub-wireless communication system 3-2, and a sub-wireless communication system 3-3. In the related art, frame transmission and/or reception is performed between one access point apparatus and a station apparatus connected to (associated with) the access point apparatus. In addition to the related art, in the Multi-AP wireless communication system, a plurality of access point apparatuses intend to perform a coordinated operation to perform frame transmission and/or reception with a station apparatus. Basically, communication areas (coverage) provided by each of the sub-wireless communication systems overlap each other. In FIG. 5, a dashed ellipse indicating each of the sub-wireless communication systems 3-1, 3-2, and 3-3 is assumed to indicate the coverage of each sub-wireless communication system. Although FIG. 5 is an example in which the Multi-AP wireless communication system includes three sub-wireless communication systems, of course, the Multi-AP wireless communication system may include a plurality of sub-wireless communication systems other than three systems.

The sub-wireless communication system 3-1 includes a wireless communication apparatus 1-1 and wireless communication apparatuses 2-1, 2-12, 2-13, and 2-123. Further the wireless communication apparatus 1-1 will also be referred to as an access point apparatus (base station apparatus) 1-1, and the wireless communication apparatuses 2-1, 2-12, 2-13, and 2-123 will also be referred to as station apparatuses (terminal apparatuses) 2-1, 2-12, 2-13, and 2-123. In addition, the wireless communication apparatuses 2-1, 2-12, 2-13, and 2-123 are also referred to as station apparatuses 2A as apparatuses connected to (associated with) the access point apparatus 1-1. The access point apparatus 1-1 and the station apparatuses 2A are wirelessly connected and are in a state in which they can transmit and/or receive PPDUs to and from each other. Furthermore, although the station apparatus 2-12 is connected to (associated with) the access point apparatus 1-1, the station apparatus 2-12 can transmit and/or receive frames for which the station apparatus performs a coordinated operation with the access point apparatus 1-2. Although the station apparatus 2-13 is connected to (associated with) the access point apparatus 1-1, the station apparatus 2-13 can transmit and/or receive frames for which the station apparatus performs a coordinated operation with an access point apparatus 1-3. Although the station apparatus 2-123 is connected to (associated with) the access point apparatus 1-1, the station apparatus 2-123 can transmit and/or receive frames for which the station apparatus performs a coordinated operation with the access point apparatus 1-2 and the access point apparatus 1-3. The station apparatuses 2-12, 2-13, and 2-123 that transmit and/or receive frames for which the station apparatuses perform a coordinated operation with an access point apparatus other than the access point apparatus connected to (associated with) the station apparatuses will also be referred to as station apparatuses 2AX. The station apparatus 2-1 transmits and/or receives frames only to and from the access point apparatus 1-1, which is a connection destination (an association destination).

The sub-wireless communication system 3-2 includes a wireless communication apparatus 1-2 and wireless communication apparatuses 2-2, 2-21, 2-23, and 2-213. Further, the wireless communication apparatus 1-2 will also be referred to as an access point apparatus (base station apparatus) 1-2, and the wireless communication apparatuses 2-2, 2-21, 2-23, and 2-213 will also be referred to as station apparatuses (terminal apparatuses) 2-2, 2-21, 2-23, and 2-213. In addition, the wireless communication apparatuses 2-2, 2-21, 2-23, and 2-213 are also referred to as station apparatuses 2B as apparatuses connected to (associated with) the access point apparatus 1-2. The access point apparatus 1-2 and the station apparatuses 2B are wirelessly connected and are in a state in which they can transmit and/or receive PPDUs to and from each other. Furthermore, although the station apparatus 2-21 is connected to (associated with) the access point apparatus 1-2, the station apparatus 2-21 can transmit and/or receive frames for which the station apparatus performs a coordinated operation with the access point apparatus 1-1. Although the station apparatus 2-23 is connected to (associated with) the access point apparatus 1-2, the station apparatus 2-23 can also transmit and/or receive frames for which the station apparatus performs a coordinated operation with the access point apparatus 1-3. Although the station apparatus 2-123 is connected to (associated with) the access point apparatus 1-1, the station apparatus 2-123 can transmit and/or receive frames for which the station apparatus performs a coordinated operation with the access point apparatus 1-2 and the access point apparatus 1-3. The station apparatuses 2-21, 2-23, and 2-213 that transmit and/or receive frames for which the station apparatuses perform a coordinated operation with an access point apparatus other than the access point apparatus connected to (associated with) the station apparatuses will also be referred to as station apparatuses 2BX. The station apparatus 2-2 transmits and/or receives frames only to and from the access point apparatus 1-2, which is a connection destination (an association destination).

The sub-wireless communication system 3-3 includes a wireless communication apparatus 1-3 and wireless communication apparatuses 2-3, 2-31, 2-32, and 2-312. Further, the wireless communication apparatus 1-3 will also be referred to as an access point apparatus (base station apparatus) 1-3, and the wireless communication apparatuses 2-3, 2-31, 2-32, and 2-312 will also be referred to as station apparatuses (terminal apparatuses) 2-3, 2-31, 2-32, and 2-312. In addition, the wireless communication apparatuses 2-3, 2-31, 2-32, and 2-312 are also referred to as station apparatuses 2C as apparatuses connected to (associated with) the access point apparatus 1-3. The access point apparatus 1-3 and the station apparatuses 2C are wirelessly connected and are in a state in which they can transmit and/or receive PPDUs to and from each other. Furthermore, although the station apparatus 2-31 is connected to (associated with) the access point apparatus 1-3, the station apparatus 2-31 can transmit and/or receive frames for which the station apparatus performs a coordinated operation with the access point apparatus 1-1. Although the station apparatus 2-32 is connected to (associated with) the access point apparatus 1-3, the station apparatus 2-32 can transmit and/or receive frames for which the station apparatus performs a coordinated operation with the access point apparatus 1-2. Although the station apparatus 2-312 is connected to (associated with) the access point apparatus 1-3, the station apparatus 2-312 can transmit and/or receive frames for which the station apparatus performs a coordinated operation with the access point apparatus 1-1 and the access point apparatus 1-2. The station apparatuses 2-31, 2-32, and 2-312 that transmit and/or receive frames for which the station apparatuses perform a coordinated operation with an access point apparatus other than the access point apparatus connected to (associated with) the station apparatuses will also be referred to as station apparatuses 2CX. The station apparatus 2-3 transmits and/or receives frames only to and from the access point apparatus 1-3, which is a connection destination (an association destination).

Although each of the wireless communication apparatuses (access point apparatuses) 1-1, 1-2, and 1-3 constitutes a corresponding (sub) wireless communication system, at least one access point apparatus, as a master access point apparatus (also referred to as a master AP, a coordinator access point apparatus, a coordinator AP, a sharing access point apparatus, a sharing AP, etc.), performs centralized control of a slave access point apparatus that is another access point apparatus (also referred to as a slave AP, a coordinated access point apparatus, a coordinated AP, a shared access point apparatus, a shared AP, etc.) and issues indications. Furthermore, the coordinator access point apparatus may also handle data frames to be transmitted to station apparatuses connecting to each access point apparatus, or data frames received from the station apparatuses. In other words, a data frame transmitted by a coordinator access point apparatus may be received by a station apparatus after passing through a coordinated access point apparatus. In addition, a data frame transmitted by a station apparatus may also be received by a coordinator access point apparatus after passing through the access point apparatus that the station apparatus is connected to (associated with).

Although a case that the coordinated access point apparatuses 1-2 and 1-3 are connected to the coordinator access point apparatus 1-1 will be described using FIG. 5 as an example according to the present embodiment, this is merely an example. The access point apparatus 1-2 may be connected to the coordinator access point apparatus 1-1, the access point apparatus 1-3 may be connected to the access point apparatus 1-2, and another access point apparatus may be connected to the access point apparatus 1-3. There is no limit on the number of access point apparatuses that can be connected in series (depth of connection and number of connections in series). In addition, two or more access point apparatuses can be connected to one (coordinator or coordinated) access point apparatus, and there is no limit on the number of access point apparatuses to be connected that are branched from one (coordinator or coordinated) access point apparatus. Thus, there are various types of connection topology of a Multi-AP wireless communication system composed of a plurality of access point apparatuses.

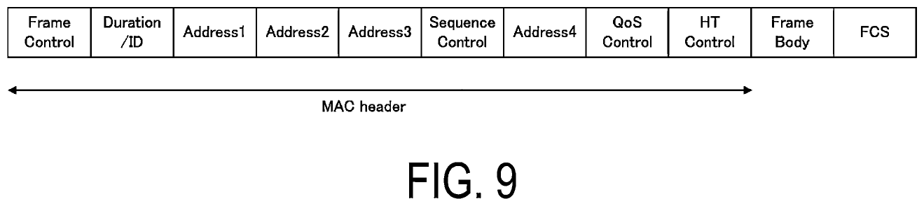

FIG. 9 illustrates an example of a MAC Frame format. The MAC Frame described herein indicates a Data frame in FIG. 1 (a MAC Frame, a MAC frame, a payload, a data unit, data, an information bit, and the like) and a MAC Frame in FIG. 2. The MAC Frame includes the fields of Frame Control, Duration/ID, Address 1, Address 2, Address 3, Sequence Control, Address 4, QoS control, HT control, Frame Body, and FCS.

Although the sub-wireless communication system 3-1, the sub-wireless communication system 3-2, and the sub-wireless communication system 3-3 form different BSSs, this does not necessarily mean that Extended Service Sets (ESSs) are different. An ESS indicates a service set forming a Local Area Network (LAN). In other words, wireless communication apparatuses belonging to the same ESS can be regarded as belonging to the same network from an upper layer. In addition, the BSSs are coupled to each other via a Distribution System (DS) to form an ESS. Further, each of the sub-wireless communication systems 3-1, 3-2, and 3-3 can further include a plurality of wireless communication apparatuses.

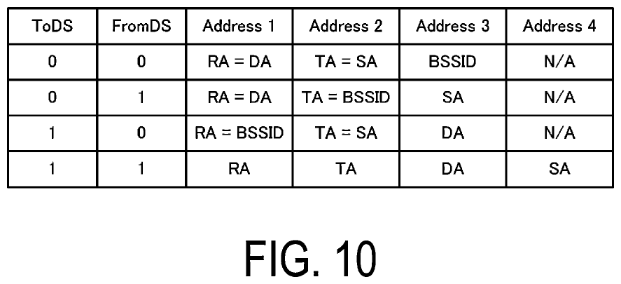

FIG. 10 summarizes the addresses written in the fields of Address 1, Address 2, Address 3, and Address 4 included in FIG. 9 categorized according to values of FromDS and ToDS in a table. Information of FromDS and ToDS is included in the field of Frame Control of FIG. 9. The value of FromDS is 1 when a frame is transmitted from a DS and 0 when a frame is transmitted from the outside of a DS. The value of ToDS is 1 when a frame is received by a DS, and 0 when a frame is received by a system other than a DS. Further, an SA refers to a Source Address (transmission source address or reference source address), and a DA refers to a Destination Address (destination address or transfer destination address). The table of FIG. 10 indicates that the meanings of Address 1 to Address 4 change in accordance with the values of FromDS and ToDS. Further, in a case that ToDS is 0 and FromDS is 0, Address 1 is denoted by “RA=DA” that is obtained by combining “RA” and “DA” with “=”, which indicates that RA and DA are the same address. In other combinations, addresses combined with “=” indicates that they are the same address.

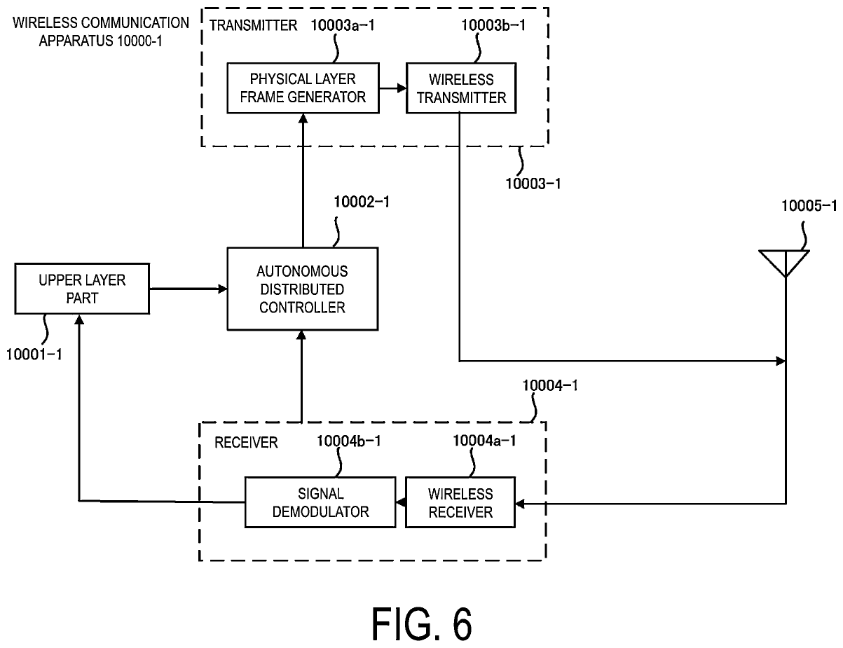

FIG. 6 is a diagram illustrating an example of an apparatus configuration of the wireless communication apparatuses 1-1, 1-2, 1-3, 2A, 2B, and 2C (hereinafter, collectively referred to as a wireless communication apparatus 10000-1). The wireless communication apparatus 10000-1 includes an upper layer part (upper layer processing step) 10001-1, an autonomous distributed controller (autonomous distributed control step) 10002-1, a transmitter (transmission step) 10003-1, a receiver (reception step) 10004-1, and an antenna 10005-1.

The upper layer unit 10001-1 is connected to another network and can notify the autonomous distributed controller 10002-1 of information about traffic. The information about traffic may be, for example, information addressed to another wireless communication apparatus, or may be control information included in a management frame or a control frame.

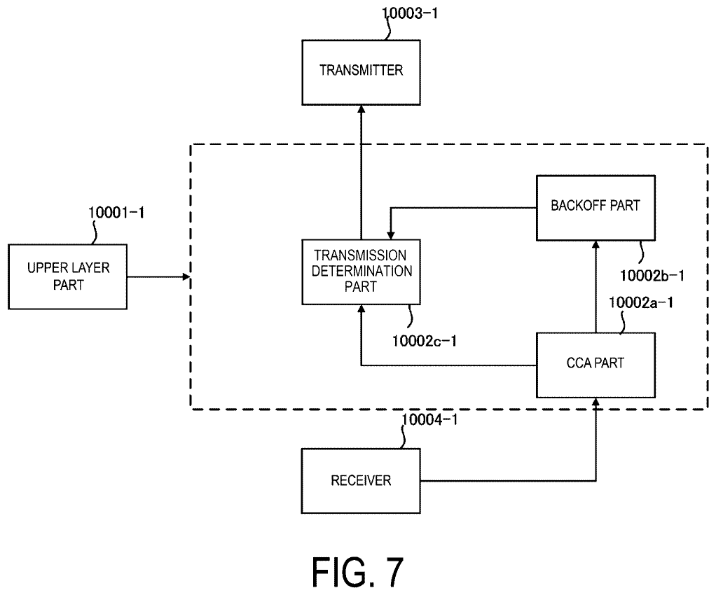

FIG. 7 is a diagram illustrating an example of an apparatus configuration of the autonomous distributed controller 10002-1. The autonomous distributed controller 10002-1 includes a CCA part (CCA step) 10002a-1, a backoff part (backoff step) 10002b-1, and a transmission determination part (transmission determination step) 10002c-1.

The CCA part 10002a-1 can determine a state of a radio resource (including determination of being busy or idle) using any one of or both information about reception signal power received via the radio resource and information about the reception signal (including information after decoding) notified by the receiver. The CCA part 10002a-1 can notify the backoff part 10002b-1 and the transmission determination part 10002c-1 of the state determination information of the radio resource.

The backoff part 10002b-1 can perform backoff using the state determination information of the radio resource. The backoff part 10002b-1 has a function of generating CW and perform countdown. For example, it is possible to perform countdown of the CW in a case that the state determination information of the radio resource indicates idle, and it is possible to stop countdown of the CW in a case that the state determination information of the radio resource indicates busy. The backoff part 10002b-1 can notify the transmission determination part 10002c-1 of the value of the CW.

The transmission determination part 10002c-1 performs transmission determination using any one of or both the state determination information of the radio resource and the value of the CW. For example, it is possible to notify the transmitter 10003-1 of the transmission determination information if the state determination information of the radio resource indicates “idle” and the value of the CW is 0. In addition, it is possible to notify the transmitter 10003-1 of the transmission determination information in a case that the state determination information of the radio resource indicates “idle”.

The transmitter 10003-1 includes a physical layer frame generator (physical layer frame generation step) 10003a-1 and a wireless transmitter (wireless transmission step) 10003b-1. The physical layer frame generator 10003a-1 has a function of generating a physical layer frame (PPDU) based on the transmission determination information notified by the transmission determination part 10002c-1. The physical layer frame generator 10003a-1 also performs error correction coding, modulation, precoding filter multiplication, and the like on transmission frames transmitted from the upper layer. The physical layer frame generator 10003a-1 notifies the wireless transmitter 10003b-1 of the generated physical layer frame.

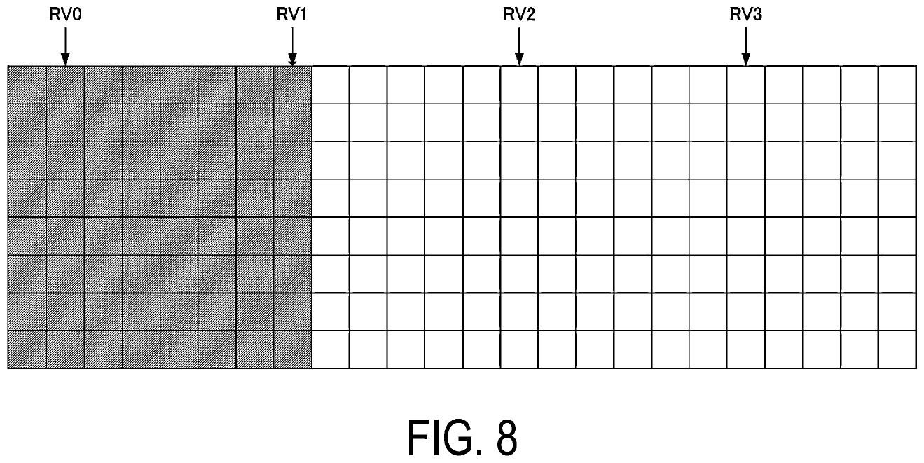

FIG. 8 is a diagram illustrating an example of error correction coding by the physical frame generator according to the present embodiment. As illustrated in FIG. 8, an information bit (systematic bit) sequence is arranged in the hatched region and a redundancy (parity) bit sequence is arranged in the white region. A bit interleaver is appropriately applied to each of the information bits and the redundancy bits. The physical frame generator can read a necessary number of bits as a start position determined for the arranged bit sequence in accordance with a value of a redundancy version (RV). It is possible to achieve a flexible change in coding rate, that is, puncturing, by adjusting the number of bits. Further, although a total of four RVs are illustrated in FIG. 8, the number of options for RV is not limited to a specific value in the error correction coding according to the present embodiment. A position of an RV needs to be shared among the station apparatuses.

Although the physical layer frame generator performs error correction coding on the information bits transferred from the MAC layer, a unit in which error correction coding is performed (coding block length) is not limited to any unit. For example, the physical layer frame generator may divide the information bit sequence transferred from the MAC layer into an information bit sequence with a predetermined length to perform error correction coding on each sequence and make it into a plurality of coding blocks. Further, dummy bits can be inserted into the information bit sequence transferred from the MAC layer when configuring coding blocks.

The frame generated by the physical layer frame generator 10003a-1 includes control information. The control information includes information indicating in which RU (here, the RU including both frequency resources and spatial resources) the data addressed to each wireless communication apparatus is arranged. In addition, the frame generated by the physical layer frame generator 10003a-1 includes a trigger frame for indicating transmission of a frame to the wireless communication apparatus that is a destination terminal. The trigger frame includes information indicating the RU used when the wireless communication apparatus that has received the indication of transmitting a frame transmits a frame.

The wireless transmitter 10003b-1 converts the physical layer frame generated by the physical layer frame generator 10003a-1 into a signal of a radio frequency (RF) band to generate a radio frequency signal. Processing performed by the wireless transmitter 10003b-1 includes digital-to-analog conversion, filtering, frequency conversion from a baseband to an RF band, and the like.

The receiver 10004-1 includes a wireless receiver (wireless reception step) 10004a-1 and a signal demodulator (signal demodulation step) 10004b-1. The receiver 10004-1 generates information about reception signal power from the signal of the RF band received by the antenna 10005-1. The receiver 10004-1 can notify the CCA part 10002a-1 of the information about the reception signal power and the information about the reception signal.

The wireless receiver 10004a-1 has a function of converting the signal of the RF band received by the antenna 10005-1 into a baseband signal and generating a physical layer signal (e.g., a physical layer frame). Processing performed by the wireless receiver 10004a-1 includes a frequency conversion process from the RF band to the baseband, filtering, and analog-to-digital conversion.

The signal demodulator 10004b-1 has a function of demodulating a physical layer signal generated by the wireless receiver 10004a-1. Processing performed by the signal demodulator 10004b-1 includes channel equalization, demapping, error correction decoding, and the like. The signal demodulator 10004b-1 can extract, from the physical layer signal, information included in the physical layer header, information included in the MAC header, and information included in the transmission frame, for example. The signal demodulator 10004b-1 can notify the upper layer part 10001-1 of the extracted information. Further, the signal demodulator 10004b-1 can extract any one or all of the information included in the physical layer header, information included in the MAC header, and information included in the transmission frame.

The antenna 10005-1 has a function of transmitting the radio frequency signal generated by the wireless transmitter 10003b-1 to a radio space toward a wireless apparatus 0-1. In addition, the antenna 10005-1 has a function of receiving a radio frequency signal transmitted from the wireless apparatus 0-1.

The wireless communication apparatus 10000-1 can cause wireless communication apparatuses in the surroundings of the apparatus itself to configure an NAV for a corresponding period in which the wireless communication apparatus uses a radio medium by describing information indicating the period in the PHY header or the MAC header of the frame to be transmitted. For example, the wireless communication apparatus 10000-1 can describe the information indicating the period in the Duration/ID field or the Length field in the frame to be transmitted. The NAV period configured for the wireless communication apparatuses in the surroundings of the wireless communication apparatus will be referred to as a TXOP period (or simply TXOP) acquired by the wireless communication apparatus 10000-1. In addition, the wireless communication apparatus 10000-1 that has acquired the TXOP will be referred to as a TXOP holder. A frame type of frame to be transmitted by the wireless communication apparatus 10000-1 to acquire a TXOP is not limited to any frame type, and the frame type may be a control frame (e.g., an RTS frame or a CTS-to-self frame) or may be a data frame.

The wireless communication apparatus 10000-1 that is a TXOP holder can transmit a frame to wireless communication apparatuses other than the wireless communication apparatus itself during the TXOP. In a case that the wireless communication apparatus 1-1 is a TXOP holder, the wireless communication apparatus 1-1 can transmit a frame to the wireless communication apparatus 2A within the TXOP period. In addition, the wireless communication apparatus 1-1 can provide an indication for transmitting a frame addressed to the wireless communication apparatus 1-1 to the wireless communication apparatus 2A within the TXOP period. The wireless communication apparatus 1-1 can transmit, to the wireless communication apparatus 2A, a trigger frame including the information for providing an indication for transmitting a frame addressed to the wireless communication apparatus 1-1 within the TXOP period.

The wireless communication apparatus 1-1 may acquire a TXOP for an entire communication band (e.g., operation bandwidth) that is likely to be used for frame transmission or may acquire a specific communication band such as a communication band that is actually used to transmit a frame (e.g., transmission bandwidth).

A wireless communication apparatus that indicates transmission of a frame within the TXOP period acquired by the wireless communication apparatus 1-1 is not necessarily limited to wireless communication apparatuses connected to the wireless communication apparatus itself. For example, the wireless communication apparatus can indicate to wireless communication apparatuses that are not connected to the wireless communication apparatus to transmit frames, in order to cause the wireless communication apparatuses in the surroundings of the wireless communication apparatus to transmit management frames such as a reassociation frame or control frames such as an RTS/CTS frame.

Furthermore, a TXOP in EDCA that is a data transmission method different from DCF will also be described. The IEEE 802.11e standard relates to EDCA and defines a TXOP in terms of guarantee of Quality of Service (QoS) for various services such as video transmission and VoIP. The services are classified broadly into four access categories, namely VOice (VO), VIdeo (VI), Best Effort (BE), and BacK ground (BK). In general, the order of services in terms of higher priority is VO, VI, BE, and BK. In each access category, there are parameters including a minimum value of a CW CWmin, a maximum value of a CW CWmax, Arbitration IFS (AIFS) that is a type of IFS, and TXOP limit that is an upper limit value of a transmission opportunity, and values are configured to have differences in priority. For example, it is possible to perform data transmission prioritized over other access categories by configuring, as compared with other access categories, a relatively small value for CWmin, CWmax, and AIFS of VO with the highest priority for the purpose of voice transmission. For example, in VI with a relatively large amount of transmission data for transmitting a video, it is possible to extend a transmission opportunity as compared with the other access categories by configuring TXOP limit to be higher. In this manner, values of four parameter of each access category are adjusted in order to assure QoS in accordance with various services.

In the present embodiment, the signal demodulator of the station apparatus can perform a decoding process and perform error detection on the received signal in the physical layer. Here, the decoding process includes a decoding process for an error correction code applied to the received signal. Here, error detection includes error detection using an error detection code (e.g., cyclic redundancy check (CRC) code) that has been pre-applied to the received signal, and error detection using an error detection code (e.g., low density parity inspection code (LDPC)) with an error detection function. The decoding process in the physical layer can be applied for each coding block.

The upper layer part transfers the result of decoding of the physical layer by the signal demodulator to the MAC layer. In the MAC layer, the signal of the MAC layer is restored from the transferred decoding result of the physical layer. In addition, error detection is performed in the MAC layer to determine whether the signal of the MAC layer transmitted by the station apparatus serving as the transmission source of the reception frame has been correctly restored.

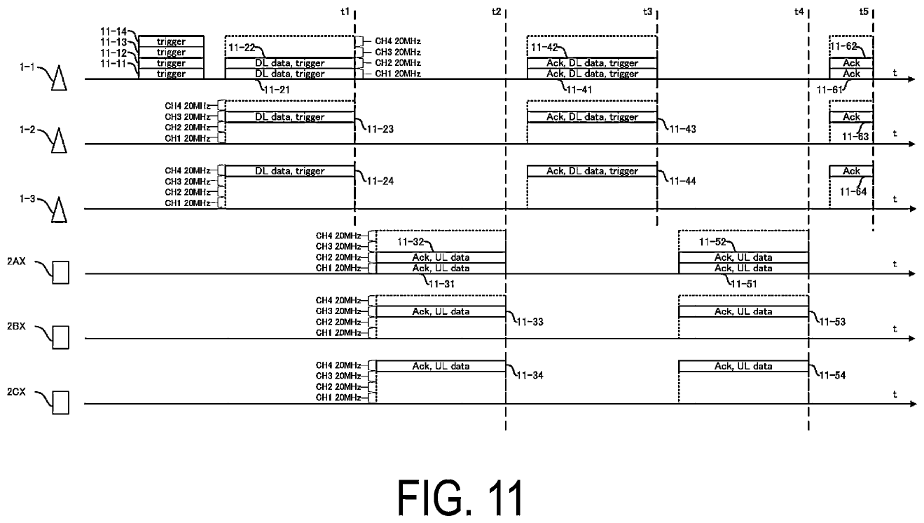

As described above, in the Multi-AP wireless communication system, the plurality of access point apparatuses perform coordinated operations to transmit and/or receive frames to and from the station apparatus. An overview of Coordinated OFDMA which is an example of a coordinated operation will be described with reference to FIG. 11. For example, it is assumed that the frequency bandwidth of the radio channel used for the Multi-AP wireless system is 80 MHz and is composed of four radio sub channels CH1, CH2, CH3, and CH4 with the frequency bandwidth of 20 MHz, the sub-wireless communication system 3-1 managed by the access point apparatus 1-1 uses CH1 and CH2, the sub-wireless communication system 3-2 managed by the access point apparatus 1-2 uses CH3, and the sub-wireless communication system 3-3 managed by the access point apparatus 1-3 uses CH4. For example, the access point apparatus 1-1 transmits a frame 11-21 and a frame 11-22 to a station apparatus 2AX, the access point apparatus 1-2 transmits a frame 11-23 to a station apparatus 2BX, and the access point apparatus 1-3 transmits a frame 11-24 to a station apparatus 2CX. Frequency resources are allocated to the frames 11-21 to 11-24 in FIG. 11 so as to be orthogonal to the frequency axis direction, and the left ends of the frames are aligned in the time axis direction, and further the right ends of the frames are aligned. This configuration indicates that the frames 11-21 to 11-24 are transmitted by OFDMA. In particular, FIG. 11 illustrates transmission to the plurality of station apparatuses connected to each of the plurality of access point apparatuses by OFDMA, which is called Coordinated OFDMA because each of the plurality of access point apparatuses performs coordinated operations. Although the combination of the frames 11-21 to frames 11-24 in the downlink direction to be transmitted from the access point apparatuses to the station apparatus has been described, the combination of frames 11-31 to 11-34 in the uplink direction transmitted from the station apparatus to the access point apparatuses may be transmitted in the same manner in Coordinated OFDMA.

In FIG. 11, the wireless communication apparatus 1-1 is a coordinator access point apparatus, and the wireless communication apparatuses 1-2 and 1-3 are coordinated access point apparatuses. The coordinator access point apparatus 1-1 recognizes, in advance, requested radio resources (frequency resources, bandwidth, the number of radio channels, spatial resources, the amount of data transmitted, the amount of data received, and the like) required by each access point apparatus. Normally, the coordinator access point apparatus makes an inquiry to the coordinated access point apparatus, and the coordinated access point apparatus responds with requested radio resources to the coordinator access point apparatus. Alternatively, each coordinated access point apparatus may autonomously notify the coordinator access point apparatus of the requested radio resources.

The coordinator access point apparatus 1-1 transmits the trigger frames 11-11 to 11-14 to each of the access point apparatuses to notify how the TXOP acquired by the coordinator access point apparatus 1-1 itself is to be allocated or distributed to each access point apparatus in accordance with the requested radio resources already obtained. In the trigger frame, radio resource allocation information with respect to each access point apparatus, total TXOP information corresponding to all TXOPs acquired by the coordinator access point apparatus, downlink TXOP information about the TXOP acquired for downlink communication, uplink TXOP information for the TXOP acquired for uplink communication, and the like are described.

For example, the downlink TXOP information includes information about transmission end times t1, t3, and the like of downlink frames from each access point apparatus to each station apparatus. The uplink TXOP information includes information about transmission end time t2, t4, and the like of uplink frames from each station apparatus to each access point apparatus. The total TXOP information includes information about an end time t5 of all downlink communication and uplink communication.

For example, it is assumed that the radio resource allocation information specifies that the coordinator access point apparatus 1-1 uses the radio channels CH1 and CH2, the coordinated access point apparatus 1-2 uses the radio channel CH3, and the coordinated access point apparatus 1-3 uses the radio channel CH4. In this case, the access point apparatus 1-1 transmits the frame 11-21 with CH1 and transmits the frame 11-22 with CH2 to the station apparatus 2AX. The access point apparatus 1-2 transmits the frame 11-23 with CH3 to the station apparatus 2BX. The access point apparatus 1-3 transmits the frame 11-24 with CH4 to the station apparatus 2CX. In other words, in the period after the reception of the trigger frames 11-11 to 11-14 to the time t5, the access point apparatus 1-1 manages CH1 and CH2 and uses the channels in the sub-wireless communication system 3-1, the access point apparatus 1-2 manages CH3 and uses the channel in the sub-wireless communication system 3-2, and the access point apparatus 1-3 manages CH4 and uses the channel in the sub-wireless communication system 3-3. Further, the allocation method for the radio channels described in this paragraph is an example for the description, and other allocation methods may be applied.

The station apparatus that has received the frames 11-21 to 11-24 transmits response frames 11-31 to 11-34 to the access point apparatuses. In addition to being downlink data frames to the station apparatus, the frames 11-21 to 11-24 serve as trigger frames for the station apparatus to transmit uplink data frames. Thus, the frames 11-31 to 11-34 that the station apparatus transmits to the access point apparatuses may include uplink data in addition to the responses to the frames 11-21 to 11-24. The access point apparatuses that have received the frames 11-31 to 11-34 transmit response frames 11-41 to 11-44 to the station apparatus. The frames 11-41 to 11-44 that the access point apparatuses transmit to the station apparatus may include downlink data in addition to the responses to the frames 11-31 to 11-34. As described above, repeated transmission and/or reception of downlink data frames and transmission and/or reception of uplink data frames in an alternating manner in the duration of one TXOP is efficient in the time axis direction since the overhead for acquiring the radio medium at the time of transmission of each data frame is reduced, and thus is called cascading frame exchange (or cascading sequence).

Further, FIG. 11 is an example in which the access point apparatuses transmit downlink frames (11-21 to 11-24) and then receive uplink frames (11-31 to 11-34), and subsequently transmit downlink frames (11-41 to 11-44), then receive uplink frames (11-51 to 11-54), and finally transmit response frames (11-61 to 11-64) to end the operation. That is, although the combination of downlink frame transmission and/or reception and uplink frame transmission and/or reception is made twice, the number of combinations thereof is not limited to two, and may be three or more. In addition, radio resource allocation information notified to each of the access point apparatuses in the trigger frames 11-11 to 11-14 is effective until all downlink frame transmission and/or reception and uplink frame transmission and/or reception end in the total TXOP durations.

The basic operation of coordinated OFDMA has been described above. Typically, radio resources (frequency resources, bandwidths, the number of radio channels, spatial resources, and the like) allocated to each of downlink communication and uplink communication are common to sub-wireless communication systems, and for example, the size and position of frequency resources are common to sub-wireless communication systems. This indicates that, in the above-described example, the access point apparatus 1-1 manages CH1 and CH2 and uses the channels in the sub-wireless communication system 3-1, the access point apparatus 1-2 manages CH3 and uses the channel in the sub-wireless communication system 3-2, and the access point apparatus 1-3 manages CH4 and uses the channel in the sub-wireless communication system 3-3. In this case, problems arise in a certain sub-wireless communication system in a case that, while a wide bandwidth is needed for downlink communication of a large volume of data, a narrow bandwidth is sufficient since the amount of data in uplink communication is small. One of the problems is that, due to a small amount of uplink data, a wide bandwidth allocated to the uplink communication period is not sufficiently utilized and thus it is not possible to fully use the bandwidth effectively.

Thus, the wireless communication apparatus according to the present embodiment is designed to be able to allocate different radio resources, for example, frequency resources with different sizes at different positions to each of downlink communication and uplink communication of each sub-wireless communication system constituting a Multi-AP wireless communication system in coordinated OFDMA.

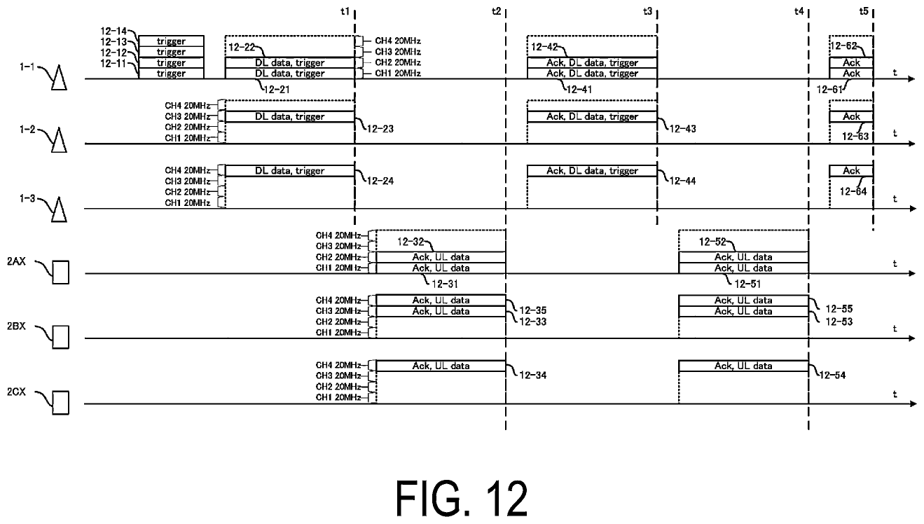

The specific description will be provided using FIG. 12. A difference between FIG. 11 and FIG. 12 is that, although the sub-wireless communication system 3-2 only uses CH3 for uplink communication in FIG. 11, the system uses CH4 in addition to CH3 for uplink communication in FIG. 12.

For example, it is assumed that a communication data amount is expressed in four levels from 1 to 4. It is assumed that the communication data amount 4 indicates the maximum, and the communication data amount 1 indicates the minimum. It is assumed that the sub-wireless communication system 3-1 has the downlink communication data amount 4, the uplink communication data amount 4, the sub-wireless communication system 3-2 has the downlink data amount 2, and the uplink data amount 3, and the sub-wireless communication system 3-3 has the downlink data amount 2 and the uplink data amount 1. These relative values of the communication data amount is calculated by the coordinator access point apparatus 1-1 in charge of centralized control, or a wireless communication apparatus or equipment equivalent thereto, in accordance with values of requested radio resource (frequency resources, bandwidths, the number of radio channels, spatial resources, downlink communication data amount, uplink communication data amount, etc.) reported by each access point in advance, and radio resources to be allocated to each access point apparatus are determined according to those values.

In this case, each access point apparatus is notified of radio resource information (frequency resources, bandwidths, the number of radio channels, spatial resources, and the like) for each of downlink communication and uplink communication in trigger frames 12-11 to 12-14. An example of allocation of frequency resources among radio resources will be described. In downlink communication, it is specified that the access point apparatus 1-1 manages CH1 and CH2 to be used by the sub-wireless communication system 3-1, the access point apparatus 1-2 manages CH3 to be used by the sub-wireless communication system 3-2, and the wireless communication apparatus 1-3 manages CH4 to be used by the sub-wireless communication system 3-3. In uplink communication, the access point apparatus 1-1 manages CH1 and CH2 to be used by the sub-wireless communication system 3-1, the access point apparatus 1-2 manages CH3 to be used by the sub-wireless communication system 3-2, and although the sub-wireless communication apparatus 1-3 manages CH4, the sub-wireless communication apparatus 1-3 non-exclusively uses the channel. More specifically, it is specified that the CH4 is to be shared between the sub-wireless communication system 3-3 and the sub-wireless communication system 3-2.

The ground for the allocation of the frequency resources described above will be described. The access point apparatus 1-1 also requires a large amount of communication data (communication data amount 4) for downlink communication and uplink communication, so the apparatus manages CH1 and CH2 to be allocated to downlink communication and manages CH1 and CH2 to be allocated to uplink communication such that the sub-wireless communication system 3-1 can use CH1 and CH2. The access point apparatus 1-2 requires a medium amount of communication data (communication data amount 2) for downlink communication and a relatively large amount of communication data (communication data amount 3) for uplink communication. Thus, while the access point apparatus 1-2 manages CH3 to be allocated to the downlink communication such that the sub-wireless communication system 3-2 can use CH3, the access point apparatus 1-2 manages CH3 to be allocated to the uplink communication such that the sub-wireless communication system 3-2 can use CH3, and performs allocation such that the frequency resources of CH4 managed by the access point apparatus 1-3 are shared. The access point apparatus 1-3 requires a medium amount of communication data (communication data amount 2) for downlink communication and a relatively small communication data amount (communication data amount 1) for uplink communication. Thus, while the access point apparatus 1-3 manages CH4 and allocates CH4 to the downlink communication such that the sub-wireless communication system 3-3 can use CH4, the access point apparatus 1-3 manages CH4 in the uplink communication and performs allocation such that the frequency resources of CH4 managed by the access point apparatus 1-3 are shared with the sub-wireless communication system 3-2 managed by the access point apparatus 1-2 because radio resources are not sufficiently used up by the sub-wireless communication system (3-3) of the access point apparatus 1-3 itself.

Although the example in which frequency resources at different positions with different sizes are allocated to each of downlink communication and uplink communication of each sub-wireless communication system constituting the Multi-AP wireless communication system has been described, a similar idea can also be applied to allocation of other different radio resources to each of downlink communication and uplink communication. For example, this idea can also be applied to allocation of spatial resources at different positions with different sizes.

That is, in uplink communication, the radio resources (frequency resource CH4 in this example) managed by a certain access point apparatus (1-3 in this example) can be used by the sub-wireless communication system (3-3 in the present example) of the certain access point apparatus itself and also be shared with another sub-wireless communication system (3-2 in this example). In other words, a certain sub-wireless communication system (3-2 in the present example) may share radio resources (frequency resource CH4 in this example) managed by another access point apparatus (1-3 in this example) constituting another sub-wireless communication system (3-3 in this example) in uplink communication.

Although the procedure in which the radio resources managed by a certain access point apparatus are shared with another access point apparatus in uplink communication has been described so far, the same idea can be applied to downlink communication. In other words, it is possible to notify each access point apparatus of sharing radio resources managed by a certain access point apparatus with another access point apparatus in downlink communication using the trigger frames 12-11 to 12-14.

In this way, the coordinator access point apparatus 1-1 can flexibly allocate radio resources for downlink communication and uplink communication to each of the access point apparatuses (1-1, 1-2, and 1-3), that is, each of the sub-wireless communication systems (3-1, 3-2, and 3-1) in accordance with the requested radio resources (frequency resources, bandwidths, the number of radio channels, spatial resources, downlink communication data amount, uplink communication data amount, and the like) from the access point apparatuses (1-1, 1-2, and 1-3) constituting each of the sub-wireless communication systems.

In this case, the access point apparatus 1-1 transmits a frame 12-21 with CH1 and transmits a frame 12-22 with CH2 to the station apparatus 2AX. The access point apparatus 1-2 transmits a frame 12-23 with CH3 to the station apparatus 2BX. The access point apparatus 1-3 transmits a frame 12-24 with CH4 to the station apparatus 2CX. In the period after the reception of the trigger frames 12-11 to 12-14 to the time t5, the access point apparatus 1-1 manages CH1 and CH2 to be used by the sub-wireless communication system 3-1, the access point apparatus 1-2 manages CH3 to be used by the sub-wireless communication system 3-2, and the access point apparatus 1-3 manages CH4 to be used by the sub-wireless communication system 3-3 in downlink communication. Further, the allocation method for the channels described in this paragraph is an example for the description, and other allocation methods may of course be applied.

The station apparatus that has received the frames 12-21 to 12-24 transmits response frames 12-31 to 12-35 to the access point apparatuses. In addition to being downlink data frames to the station apparatus, the frames 12-21 to 12-24 serve as trigger frames for the station apparatus to transmit uplink data frames. Thus, the frames 12-31 to 12-35 that the station apparatus transmits to the access point apparatuses may include uplink data in addition to the responses to the frames 12-21 to 12-24. The station apparatus 2AX performs uplink communication with the frame 12-31 and the frame 12-32 with CH1 and CH2 managed by the access point apparatus 1-1 and used in the sub-wireless communication system 3-1. The station apparatus 2BX performs uplink communication with the frame 12-33 with CH3 managed by the access point apparatus 1-2 and used in the sub-wireless communication system 3-2. Furthermore, the station apparatus 2BX can share CH4 managed by the access point apparatus 1-3 with the station apparatus 2CX in the sub-wireless communication system 3-3 (the station apparatus 2CX being connected to (associated with) the access point apparatus 1-3) to transmit the frame 12-35. The station apparatus 2CX performs uplink communication with the frame 12-34 by sharing CH4 managed by the access point apparatus 1-3 with the station apparatus 2BX in the sub-wireless communication system 3-2.

In other words, the sub-wireless communication system 3-1 uses CH1 and CH2 exclusively in uplink communication in the period after reception of the trigger frames 12-11 to 12-14 to the time t5. The sub-wireless communication system 3-2 may use CH3 exclusively and share CH4 managed by the access point apparatus 1-3 constituting the sub-wireless communication system 3-3. While the access point apparatus 1-3 manages CH4, the access point apparatus 1-3 may allow use of CH4 in the sub-wireless communication system 3-2 to be shared. Further, the allocation method for the channels described in this paragraph is an example for the description, and other allocation methods may of course be applied. In this manner, it is possible to efficiently use radio resources in the Multi-AP wireless communication system by allowing a certain wireless communication system (3-2 in this example) to share radio resources managed by the access point apparatus (1-3 in this example) constituting another wireless communication system (3-3 in this example).

Although the specific example in which the radio resources managed by a certain access point apparatus are shared with another access point apparatus in uplink communication has been described in FIG. 12, the same idea can be applied to downlink communication. That is, it is possible to notify each access point apparatus of sharing radio resources managed by a certain access point apparatus with another access point apparatus in downlink communication using the trigger frames 12-11 to 12-14 to perform downlink communication according to the notified allocated radio resources.

The access point apparatuses that have received the frames 12-31 to 12-35 transmit response frames 12-41 to 12-44 to the station apparatus. The frames 12-41 to 12-44 that the access point apparatuses transmit to the station apparatus may include downlink data in addition to the responses to the frames 12-31 to 12-35. As described above, repeated transmission and/or reception of downlink data frames and transmission and/or reception of uplink data in an alternating manner in the duration of one TXOP that is cascading frame exchange (or cascading sequence) can be performed.

Further, FIG. 12 is an example in which the access point apparatuses transmit downlink frames (12-21 to 12-24) and then receive uplink frames (12-31 to 12-35), and subsequently transmit downlink frames (12-41 to 12-44), then receive uplink frames (12-51 to 12-55), and finally transmits response frames (11-61 to 11-64) to end the operation. That is, although the combination of downlink frame transmission and/or reception and uplink frame transmission and/or reception is made twice, the number of combinations thereof is not limited to two, and may be three or more. In addition, channel allocation information notified to each of the access point apparatuses in the trigger frames 12-11 to 12-14 is effective until all downlink frame transmission and/or reception and uplink frame transmission and/or reception end in the total TXOP durations.

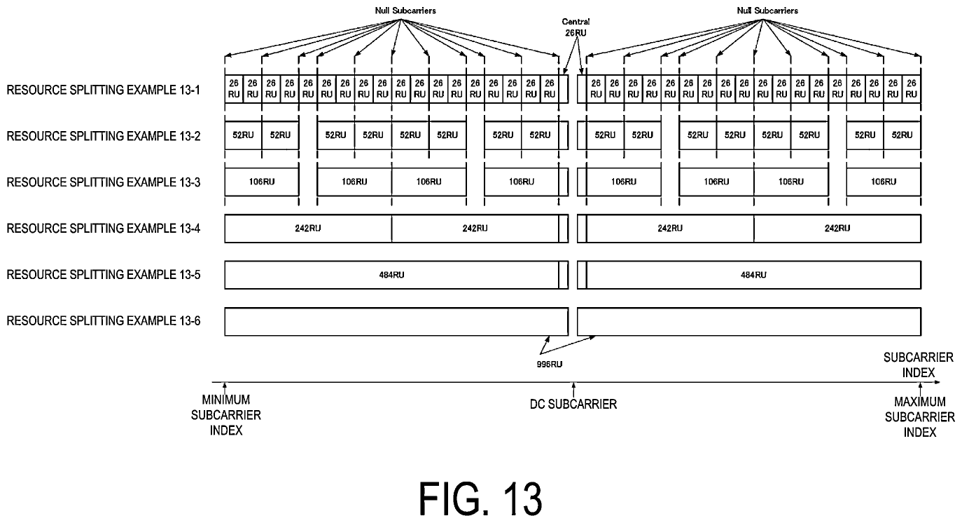

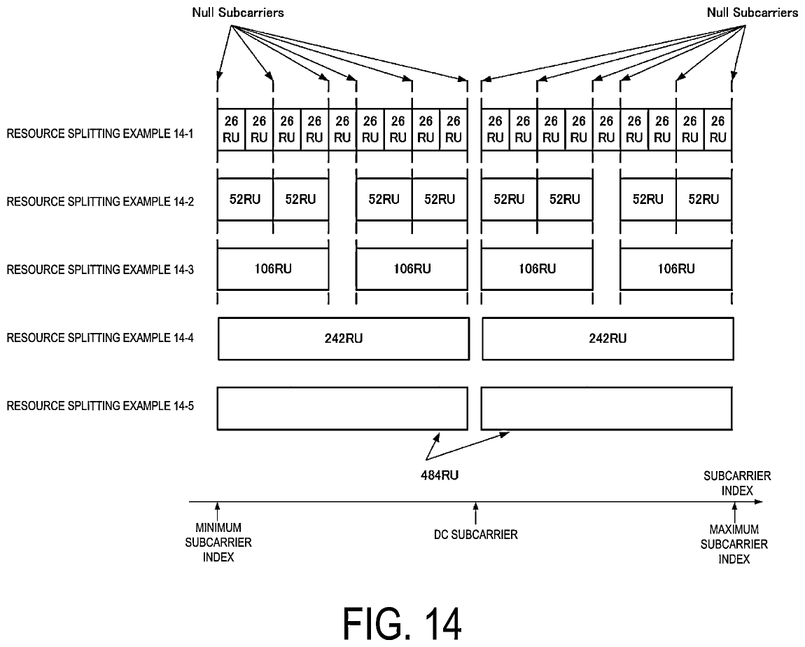

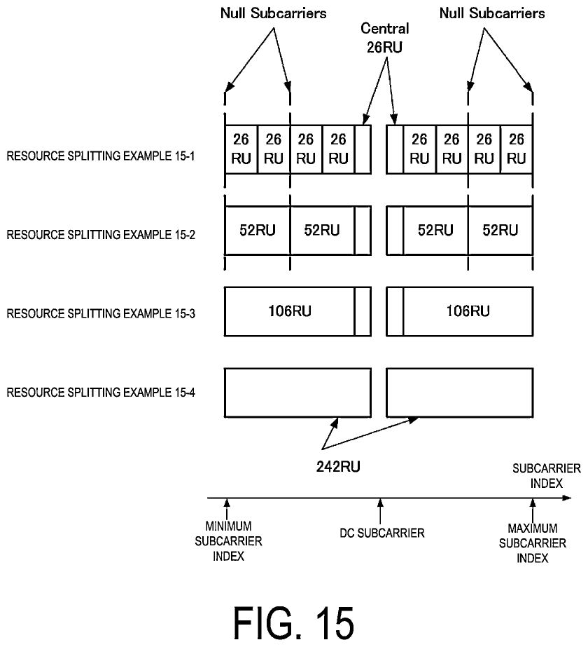

Next, a specific radio resource allocation method will be described using FIGS. 13 to 15. Although an example of a resource splitting example is illustrated in FIG. 4, FIGS. 13 to 15 are resource splitting examples defined by the IEEE 802.11ax. The unit of resource splitting is resource unit (RU) described above. In a case that a wireless communication system is configured in the 80 MHz bandwidth, there are resource splitting examples such as examples 13-1 to 13-6 illustrated in FIG. 13 (13-1 is a splitting example for 26 RU, 13-2 is a splitting example for 52 RU, 13-3 is a splitting example for 106 RU, 13-4 is a splitting example for 242 RU, 13-5 is a splitting example for 484 RU, and 13-6 is a splitting example for 996 RU), and the minimum unit is 26 RU, and the maximum unit is 996 RU. In a case that a wireless communication system is configured in the 40 MHz bandwidth, there are resource splitting examples such as examples 14-1 to 14-5 illustrated in FIG. 14 (14-1 is a splitting example for 26 RU, 14-2 is a splitting example for 52 RU, 14-3 is a splitting example for 106 RU, 14-4 is a splitting example for 242 RU, and 14-5 is a splitting example for 484 RU), and the minimum unit is 26 RU, and the maximum unit is 484 RU. In a case that a wireless communication system is configured in the 20 MHz bandwidth, there are resource splitting examples such as examples 15-1 to 15-4 illustrated in FIG. 15 (15-1 is a splitting example for 26 RU, 15-2 is a splitting example for 52 RU, 15-3 is a splitting example for 106 RU, and 15-4 is a splitting example for 242 RU), and the minimum unit is 26 RU, and the maximum unit is 242 RU.

In FIG. 12, the access point apparatus 1-1 constitutes the sub-wireless communication system 3-1 in the 40 MHz bandwidth (CH1 and CH2), and uses radio resources allocated by the resource split according to the example illustrated in FIG. 14. The access point apparatus 1-2 constitutes the sub-wireless communication system 3-2 in the 20 MHz (CH3) bandwidth, and uses radio resources allocated by the resource split according to the example illustrated in FIG. 15. The access point apparatus 1-3 constitutes the sub-wireless communication system 3-3 in the 20 MHz (CH4) bandwidth, and uses radio resources allocated by the resource split according to the example illustrated in FIG. 15. The access point apparatuses can transmit frames to a plurality of station apparatuses in downlink communication at the same time by allocating, in each of the RUs, downlink frames addressed to each of the station apparatuses. Each of the station apparatuses can perform uplink communication to transmit frames simultaneously from the plurality of station apparatuses by allocating the uplink frames in the RUs specified by the access point apparatuses. The access point apparatus can describe information (resource allocation information) indicating the state of split radio resources as common control information in the PHY header of the frames to be transmitted to the station apparatus connected to (associated with) the access point apparatus itself. Moreover, the access point apparatus can describe information (resource unit assignment information) indicating a RU allocated to each station apparatus as unique control information in the PHY header of the frames to be transmitted to the station apparatus connected to (associated with) the access point apparatus itself.

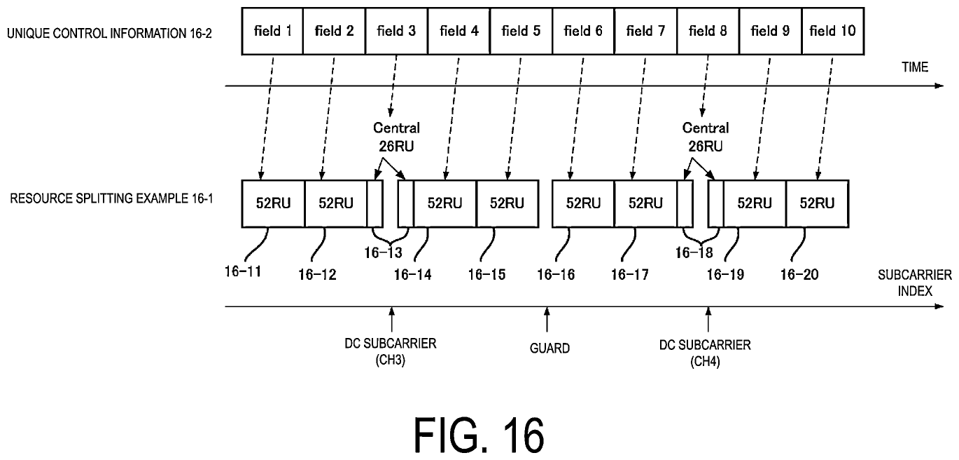

In the present example, the access point apparatus 1-2 manages the radio resources of CH3, and the access point apparatus 1-3 manages the radio resources of CH4. An example in which the radio resources of CH4 managed by the access point apparatus 1-3 are allocated to the sub-wireless communication system 3-2 including the access point apparatus 1-2 will be described using FIG. 16. In FIG. 16, NULL SubCarriers are not illustrated, and although resource split in units of 52 RU and 26 RU is described as an example, a resource splitting method is not limited to this example. CH3 is composed of RU 16-11 to RU 16-15, and CH4 is composed of RU 16-16 to RU 16-20. For example, to the sub-wireless communication system 3-2, contiguous radio resources RU 16-16 and RU 16-17 out of the radio resources of CH4 managed by the access point apparatus 1-3 may be allocated and allowed to be used, or non-contiguous RUs, such as the combination of RU 16-16 and RU 16-18, of the radio resources of CH4 may be allocated and allowed to be used.

The radio resources provided to the access point apparatus 1-2 from the access point apparatus 1-3 are calculated by the coordinator access point apparatus 1-1 in response to the requested radio resources of each access point constituting the Multi-AP wireless system, and are notified to the access point apparatus 1-2 in advance. Alternatively, radio resources that are not used by the access point apparatus 1-3 may be notified to the coordinator access point apparatus 1-1, and the coordinator access point apparatus 1-1 may notify the resources to the access point apparatus 1-2 based on the aforementioned notification.

The content indicated in the PHY header of the frame transmitted by the access point apparatus 1-2 will be described. As described above, information indicating a state of splitting radio resources (resource allocation information) as common control information is described. Although the resource splitting example 16-1 is selected and described in FIG. 16, there are various patterns in resource split example as specified from among the resource splitting examples 13-1 to 13-6 as exemplified in FIG. 13, as specified from among the resource splitting examples 14-1 to 14-5 as exemplified in FIG. 14, and as specified from among the resource splitting examples 15-1 to 15-4 in FIG. 15, and the like. Further, although the bandwidth shared by the sub-wireless communication system 3-2 and the sub-wireless communication system 3-3 is 40 MHz in the example of FIG. 16, the bandwidth is not limited thereto, and may change depending on the radio channel, and the size of frequency resources supplied from other access point apparatuses.

Next, as unique control information, information for allocating each RU specified in the resource allocation information to each station apparatus (Resource Unit Assignment Information) is described. FIG. 16 illustrates unique control information 16-2 composed of a field 1 to a field 10, and each field is information about each RU associated with a dashed arrow. Further, although the number of fields is ten in this example, it changes in accordance with the state of resource split actually specified in the resource allocation information. Each field stores information about the identifier of a station apparatus (such as the Association ID), a modulation scheme MCS (modulation and coding scheme), beam forming, and the like. The station apparatus specified with the identifier transmits and/or receives frames in the associated RU. Although the access point apparatus 1-2 describes resource unit assignment information of only CH3 (20 MHz bandwidth) managed by the apparatus itself in the PHY header and transmits the information in the related art, in this example, resource unit assignment information of the 40 MHz bandwidth also including CH4 managed by the other access point apparatus 1-3 supplying the radio resources in addition to CH3 is indicated in the PHY header and transmitted.

However, the resource unit assignment information of unique control information may include only information of the station apparatus in the sub-wireless communication system 3-2 managed by the access point apparatus 1-2, and include null information (null value, information indicating that the corresponding apparatus is not a target, association ID that is not present, or the like) of the station apparatus in the sub-wireless communication system 3-3 managed by the access point apparatus 1-3. A specific example will be described using FIG. 16. In a case that the sub-wireless communication system 3-2 configured by the access point apparatus 1-2 can use the RU 16-16 and the RU 16-18 included in CH4 in addition to CH3 (16-11 to 16-15), information about the RU 16-11 is indicated in field 1, information about the RU 16-12 is indicated in field 2, information about the RU 16-13 is indicated in field 3, information about the RU 16-14 is indicated in field 4, information about the RU 16-15 is indicated in field 5, information about the RU 16-16 is indicated in field 6, null information is indicated in field 7, information about the RU 16-18 is indicated in field 8, and null information is indicated in field 9 and field 10 (or the fields are set to be non-existent).

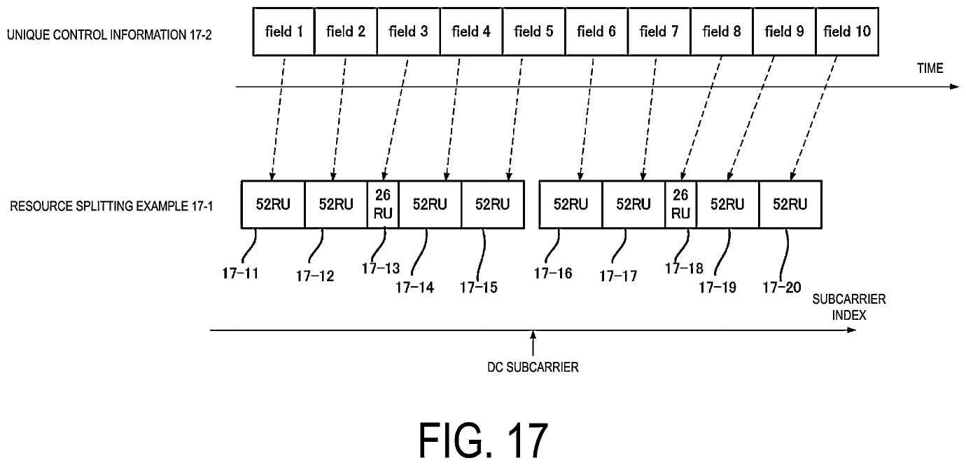

FIG. 16 illustrates that there are DC subcarriers in each channel of a two-channel configuration of 20 MHz+20 MHz in order to clearly indicate that the access point apparatus 1-2 manages CH3 of the 20 MHz bandwidth and the access point apparatus 1-3 manages CH4 of the 20 MHz bandwidth. However, in the case that a single channel configuration of 40 MHz is easy to handle in terms of implementation, the RU allocation with one DC subcarrier as illustrated in FIG. 17 may apply, and CH3 includes RU 17-11 to RU 17-15, and CH4 includes RU 17-16 to RU 17-20. In addition, description will be provided with a selected resource splitting example 17-1. In the sub-wireless communication system 3-2 and the sub-wireless communication system 3-3, RU are allocated such that RUs to be used do not overlap in this case, but frames to be handled by each sub-wireless communication system are in the 40 MHz bandwidth. In addition, similarly to FIG. 16, in unique control information 17-2 including field 1 to field 10, each field is information about each RU associated with a dashed arrow. Each field stores information about the identifier of a station apparatus (such as the Association ID), a modulation scheme MCS (modulation and coding scheme), beam forming, and the like. In a case that the sub-wireless communication system 3-2 configured by the access point apparatus 1-2 can use the RU 17-16 and the RU 17-18 included in CH4 in addition to CH3 (17-11 to 17-15), information about the RU 17-11 is indicated in field 1, information about the RU 17-12 is indicated in field 2, information about the RU 17-13 is indicated in field 3, information about the RU 17-14 is indicated in field 4, information about the RU 17-15 is indicated in field 5, information about the RU 17-16 is indicated in field 6, null information is indicated in field 7, information about the RU 17-18 is indicated in field 8, and null information is indicated in field 9 and field 10 (or the fields are set to be non-existent).

In the description provided above, as the identifier indicated in each field of the resource unit association information of the unique control information, an association ID for each access point apparatus to distinguish a station apparatus is exemplified. However, the numbering space of the association ID is neither isolated nor independent among the sub-wireless communication systems, and thus the same association ID may be used and overlap in different sub-wireless communication systems. For this reason, information about the station apparatus in another wireless communication system indicated in the unique control information is set to null information. This problem can be solved by providing a new identifier that enables to distinguish all station apparatuses positioned in a Multi-AP wireless communication system (Multi-AP association ID), separately from the association ID used to distinguish all station apparatuses positioned in a sub-wireless communication system of the related art. Thus, in a case that a Multi-AP association ID is used as the identifier indicated in each field of the resource unit assignment information of the unique control information, information about the station apparatus in another sub-wireless communication system may not be null information.

In addition, the following configuration can apply by using a Multi-AP association ID as the identifier indicated in each field of the resource unit assignment information of the unique control information. An access point apparatus can describe information of a station apparatus that is not connected to (associated with) the access point apparatus itself as well as information about a station apparatus that is connected to (associated with) the access point apparatus itself in the information (resource unit assignment information) indicating a RU allocated to each station apparatus as unique control information. The reason for this is that Multi-AP association IDs do not overlap in the Multi-AP wireless system.

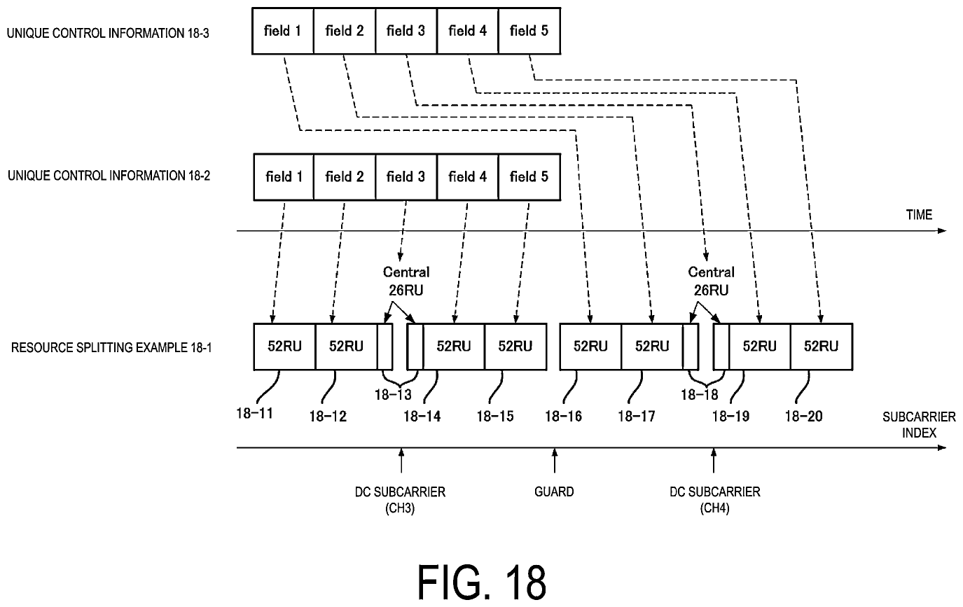

Although the configuration will be described in detail using FIG. 18 based on FIG. 16, the difference from FIG. 16 is that unique control information is divided into two. A resource splitting example 18-1 is selected, CH3 is composed of RU 18-11 to RU 18-15, and CH4 is composed of RU 18-16 to RU 18-20. The access point apparatus 1-2 describes unique control information 18-2, which is resource unit association information of CH3 in the PHY header and transmits it. The access point apparatus 1-3 describes unique control information 18-3, which is resource unit association information of CH4 in the PHY header and transmits it. For example, it is assumed that the RU 18-16 and the RU 18-18 of the radio resources of CH4 managed by the access point apparatus 1-3 are allocated to the sub-wireless communication system 3-2 managed by the access point apparatus 1-2. In this case, the access point apparatus 1-3 describes the Multi-AP association ID of the station apparatus connected to the access point apparatus 1-2 in the identifier of each of field 1 (which stores information about the RU 18-16) and field 3 (which stores information about the RU 18-18) of the unique control information 18-3 and transmits the ID. In a case that the station apparatus connected to the access point apparatus 1-2 receives the unique control information of the PHY header transmitted by the access point apparatus 1-3 that is not a connection destination (not an association destination) and that the value of the identifier matches the identifier (Multi-AP association ID and the like) of the station apparatus itself, the station apparatus can recognize that the radio resources managed by the access point apparatus 1-3 are allocated.

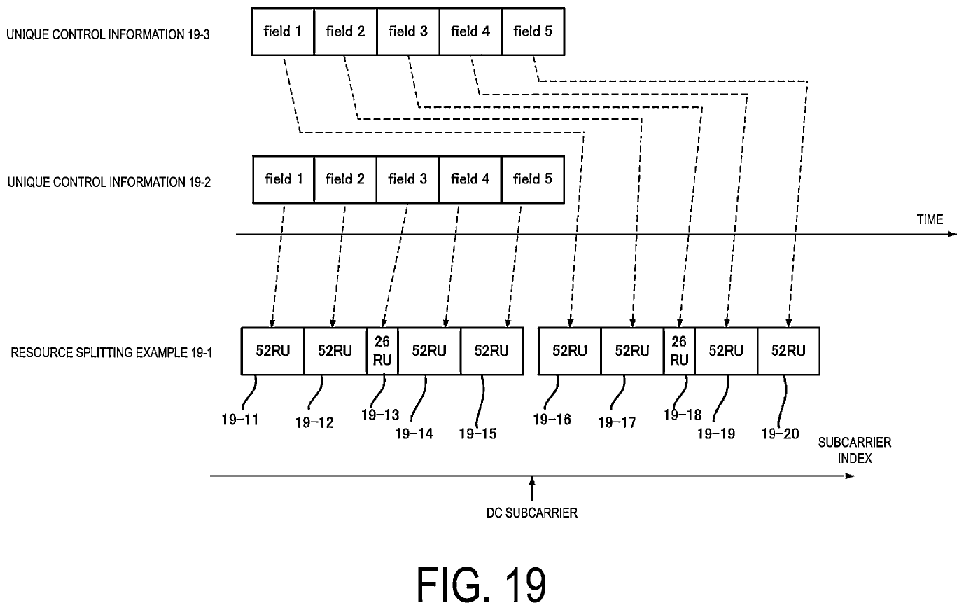

Likewise, although the configuration will be described in detail using FIG. 19 based on FIG. 17, the difference from FIG. 17 is that unique control information is divided into two. The difference from FIG. 18 is the position of the DC subcarrier. A resource splitting example 19-1 is selected, CH3 is composed of RU 19-11 to RU 19-15, and CH4 is composed of RU 19-16 to RU 19-20. The access point apparatus 1-2 describes unique control information 19-2, which is resource unit association information of CH3 in the PHY header and transmits it. The access point apparatus 1-3 describes unique control information 19-3, which is resource unit association information of CH4 in the PHY header and transmits it. For example, it is assumed that the RU 19-16 and the RU 19-18 of the radio resources of CH4 managed by the access point apparatus 1-3 are allocated to the sub-wireless communication system 3-2 managed by the access point apparatus 1-2. In this case, the access point apparatus 1-3 describes the Multi-AP association ID of the station apparatus connected to the access point apparatus 1-2 in the identifier of each of field 1 (which stores information about the RU 19-16) and field 3 (which stores information about the RU 19-18) of the unique control information 19-3 and transmits the unique control information 19-3. In a case that the station apparatus connected to the access point apparatus 1-2 receives the unique control information of the PHY header transmitted by the access point apparatus 1-3 that is not a connection destination (not an association destination) and that the value of the identifier matches the identifier (Multi-AP association ID and the like) of the station apparatus itself, the station apparatus can recognize that the radio resources managed by the access point apparatus 1-3 are allocated.

As described so far, basically, an association ID, a Multi-AP association ID, and the like are configured for the identifier of each field of resource unit assignment information, which is unique control information, and the station apparatus to which a split radio resource or RU is to be allocated is specified. Another method may be configured such that, a special value indicating that any station apparatus may use corresponding radio resources and RUs is configured, without specifying a specific station apparatus in each field, and each station apparatus may use the radio resources and RUs on a contention basis.

### 2. Matters Common to all Embodiments

Although the communication apparatus according to an aspect of the present invention can perform communication in a frequency band (frequency spectrum) that is a so-called unlicensed band that the communication apparatus does not need to be allowed to use by a nation or a region, an available frequency band is not limited thereto. The communication apparatus according to an aspect of the present invention can exhibit its effect in a frequency band called a white band that is actually not used (e.g., a frequency band that is allocated for television broadcasting but is not used depending on regions) for the purpose of preventing interference between frequencies or a shared spectrum (shared frequency band) which is expected to be shared by a plurality of service providers, for example, even though a nation or a region has allowed use of the band and spectrum in a specific service.

A program operated by the wireless communication apparatus according to an aspect of the present invention is a program (a program for causing a computer to function) for controlling a CPU or the like to implement the functions of the aforementioned embodiments related to an aspect of the present invention. In addition, information handled by these apparatuses is temporarily held in a RAM at the time of processing, is then stored in various types of ROMs and HDDs, and is read by the CPU as necessary to be corrected and written. Any of a semiconductor medium (e.g., a ROM, a non-volatile memory card, etc.), an optical recording medium (e.g., a DVD, an MO, an MD, a CD, a BD, etc.), a magnetic recording medium (e.g., a magnetic tape, a flexible disk, etc.), and the like can be an example of a recording medium for storing such a program. In addition to implementing the functions of the aforementioned embodiments by performing loaded programs, the functions of the present invention may be implemented by the programs running cooperatively with an operating system, other application programs, or the like in accordance with instructions included in those programs.

In a case of delivering these programs to market, the programs can be stored and distributed in a portable recording medium, or transferred to a server computer connected via a network such as the Internet. In this case, storage devices in the server computer are also included in an aspect of the present invention. Also, a part or an entirety of the communication apparatus in the aforementioned embodiments may be implemented as an LSI that is typically an integrated circuit. The functional blocks of the communication apparatus may be individually implemented as chips or may be partially or completely integrated into a chip. In a case that the functional blocks are integrated in a circuit, an integrated circuit controller for controlling them is added.

The circuit integration technique is not limited to LSI, and the integrated circuits for the functional blocks may be realized as dedicated circuits or a multi-purpose processor. Moreover, in a case that with advances in semiconductor technology, a circuit integration technology with which an LSI is replaced appears, it is also possible to use an integrated circuit based on the technology.

Note that the invention of the present application is not limited to the above-described embodiments. The wireless communication apparatus according to the invention of the present application is not limited to the application in the mobile station apparatus, and, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

The embodiments of the invention have been described in detail thus far with reference to the drawings, but the specific configuration is not limited to the embodiments. Other designs and the like that do not depart from the essential spirit of the invention also fall within the scope of the aspects.

### INDUSTRIAL APPLICABILITY

An aspect of the present invention can be preferably used in a communication apparatus and a communication method.

### REFERENCE SIGNS LIST

1-1, 1-2, 1-3 Access point apparatus
2-1, 2-12, 2-13, 2-123, 2-2, 2-21, 2-23, 2-213, 2-3, 2-31, 2-32, 2-312 Station apparatus
3-1, 3-2, 3-3 (Sub)wireless communication system
10001-1 Upper layer part
10002-1 Autonomous distributed controller
10002a-1 CCA part
10002b-1 Backoff part
10002c-1 Transmission determination part
10003-1 Transmitter
10003a-1 Physical layer frame generator
10003b-1 Wireless transmitter
10004-1 Receiver
10004a-1 Wireless receiver
10004b-1 Signal demodulator
10005-1 Antenna
11-11 to 11-14, 11-21 to 11-24, 11-31 to 11-34, 11-41 to 11-44, 11-51 to 11-54, 11-61 to 11-64 Frame
12-11 to 12-14, 12-21 to 12-24, 12-31 to 12-35, 12-41 to 12-44, 12-51 to 12-55, 12-61 to 12-64 Frame
13-1 to 13-6 Resource splitting example
14-1 to 14-5 Resource splitting example
15-1 to 15-4 Resource splitting example
16-1 Resource splitting example
16-2 Unique control information
17-1 Resource splitting example
17-2 Unique control information
18-1 Resource splitting example
18-2 to 18-3 Unique control information
19-1 Resource splitting example
19-2 to 19-3 Unique control information

1. A terminal apparatus for connecting, in a wireless communication system including a first sub-wireless communication system for managing a first radio resource and a second sub-wireless communication system for managing a second radio resource, to the first sub-wireless communication system, wherein
the terminal apparatus is capable of performing communication using the second radio resource in addition to the first radio resource.

2. The terminal apparatus according to claim 1, wherein
the second radio resource used for the communication is
associated with an identifier of the terminal apparatus in the first sub-wireless communication system, and
notified in control information of the first sub-wireless communication system.

3. The terminal apparatus according to claim 1, wherein
the second radio resource used for the communication is
associated with an identifier of the terminal apparatus in the wireless communication system, and
notified in control information of the second sub-wireless communication system.

4. A terminal apparatus for connecting, in a wireless communication system including a first sub-wireless communication system and a second sub-wireless communication system, to the first sub-wireless communication system, wherein
downlink communication is configured to be performed using a first radio resource managed by the first sub-wireless communication system, and
uplink communication is configured to be performed using a second radio resource managed by the second sub-wireless communication system, in addition to the first radio resource.

5. The terminal apparatus according to claim 4, wherein
the second radio resource used for the uplink communication is associated with an identifier of the terminal apparatus in the first sub-wireless communication system, and is notified in control information of the first sub-wireless communication system.

6. The terminal apparatus according to claim 4, wherein
the second radio resource used for the uplink communication is associated with an identifier of the terminal apparatus in the wireless communication system, and is notified in control information of the second sub-wireless communication system.

7. A terminal apparatus for connecting, in a wireless communication system including a first sub-wireless communication system and a second sub-wireless communication system, to the first sub-wireless communication system, wherein
uplink communication is configured to be performed using a first radio resource managed by the first sub-wireless communication system, and
downlink communication is configured to be performed using a second radio resource managed by the second sub-wireless communication system, in addition to the first radio resource.

8. The terminal apparatus according to claim 7, wherein
the second radio resource used for the downlink communication is associated with an identifier of the terminal apparatus in the first sub-wireless communication system, and is notified in control information of the first sub-wireless communication system.

9. The terminal apparatus according to claim 7, wherein
the second radio resource used for the downlink communication is associated with an identifier of the terminal apparatus in the wireless communication system, and is notified in control information of the second sub-wireless communication system.

10-13. (canceled)
